(19) United States
(12) Patent Application Publication
(10) Pub. No.: US 2018/0187954 A1
(43) Pub. Date: Jul. 5, 2018

(54) HOME APPLIANCE, MOBILE DEVICE AND CONTROL METHOD OF THE SAME

(71) Applicant: SAMSUNG ELECTRONICS CO., LTD., Suwon-si (KR)

(72) Inventors: Hee Kyung YANG, Suwon-si (KR); Hwan Hee GIL, Suwon-si (KR); Mun Keun LEE, Suwon-si (KR); A Ra CHO, Hwaseong-si (KR); Tae Hoon HA, Yongin-si (KR)

(73) Assignee: SAMSUNG ELECTRONICS CO., LTD., Suwon-si (KR)

(21) Appl. No.: 15/858,676

(22) Filed: Dec. 29, 2017

Related U.S. Application Data
(60) Provisional application No. 62/441,790, filed on Jan. 3, 2017.

(30) Foreign Application Priority Data
Feb. 23, 2017 (KR) 10-2017-0024016

(51) Int. Cl. F25D 23/02; G06Q 30/06; G06F 3/0488; G06F 3/0481; G06F 3/041

(52) U.S. Cl. CPC F25D 23/028; G06Q 30/0643; F25D 2400/361; G06F 3/04817; G06F 3/0416; G06F 3/0488

(57) ABSTRACT

A home appliance capable of minimizing a purchasing process for products required for the user or maintenance and repair of home appliances to allow a user to easily order the products at the appropriate time, and a control method of the home appliance. A home appliance comprises a user interface configured to display at least one immediate order icon purchasing a product immediately, and configured to receive a user's selection related to the displayed at least one immediate order icon, a controller configured to generate order information for ordering a product corresponding the selected immediate order icon, when the user's selection related to the at least one immediate order icon is input; and a communicator configured to transmit the generated order information to a sales server selling the product corresponding the selected immediate order icon.

### CROSS-REFERENCE TO RELATED APPLICATION(S)

This application claims the benefit of Korean Patent Application No. 10-2017-0024016, filed on Feb. 23, 2017 and US. Provisional Application No. 62/441,790 filed on Jan. 3, 2017, the disclosure of which is incorporated herein by reference.

### BACKGROUND

### 1. Field

Embodiments of the present disclosure relate to a home appliance capable of communicating with a server, a mobile device capable of communicating with the home appliance through the server, and a control method of the home appliance.

### 2. Description of Related Art.

Recently, thanks to a communication device, home appliances such as refrigerators, washing machines, and air conditioners can be connected to a server connected to Internet. A plurality of home appliances may be connected to each other via the server. In addition, the plurality of home appliances may be connected to an external sever via the server to receive the necessary service from the external server.

As for a refrigerator provided with a user interface configured to provide information to a user and receive an input from a user, the user may input a command using the user interface provided in the home appliance so as to receive a variety of services from a plurality of servers connected to Internet.

### SUMMARY

Therefore, it is an aspect of the present disclosure to provide a home appliance capable of minimizing a purchasing process for products required for the user or maintenance and repair of home appliances to allow a user to easily purchase the products at the appropriate time, and a control method of the home appliance.

It is another aspect of the present disclosure to provide a home appliance capable of providing a graphical user interface based on a user's product purchase history to help the user in re-purchasing the product quickly without repeating an operation performed when purchasing products in previous, and a control method of the home appliance

Additional aspects of the present disclosure will be set forth in part in the description which follows and, in part, will be obvious from the description, or may be learned by practice of the invention.

In accordance with one aspect of the present disclosure, a home appliance comprises: a user interface configured to display at least one immediate order icon to order at least one product corresponding to the displayed at least one immediate order icon immediately when the at least one immediate order icon is selected, and configured to receive a user's selection related to the displayed at least one immediate order icon, a controller configured to generate order information to order a product corresponding to the selected at least one immediate order icon, when the user's selection related to the at least one immediate order icon is received; and a communicator configured to transmit the generated order information to a sales server which processes an order of the product corresponding the selected at least one immediate order icon based on the generated order information.

The controller may be configured to generate the order information based on information related to the product corresponding the selected at least one immediate order icon, the information including at least one of shipping information of the user and payment information about a payment method used for purchasing the product.

The controller may be configured to generate the order information based on a previous previously ordered history of the product corresponding to the selected at least one immediate order icon.

The controller may be configured to access the sales server which processes an order of the product corresponding the selected at least one immediate order icon when the user's selection related to the at least one immediate order icon is received; and the user interface may be configured to display a screen provided from the sales server.

The communicator may be configured to transmit an order signal for ordering the product corresponding to the selected at least one immediate order icon, together with the order information to the sales server.

The user interface may be configured to display a order confirmation screen to receive an input of the confirmation of the order from the user based on the order information.

When a order button displayed on the order confirmation screen is selected, the controller may be configured to control the communicator so that the communicator transmits a order signal for purchasing the product corresponding to the selected at least one immediate order icon, to the sales server.

The communicator may be configured to transmit a order signal for purchasing the product corresponding to the selected at least one immediate order icon, together with the order information to the sales server.

The user interface may be configured to display a order completion confirmation screen which indicates that the order based on the order information is completed.

The communicator may be connected to a management server which manages home appliances and may be configured to transmit the order information to the sales server via the management server.

The controller may be configured to generate the immediate order icon based on the number of order product, and is configured to control the user interface so that the user interface displays the generated at leaste one immediate order icon.

The controller may be configured to generate the at least one immediate order icon corresponding to the product when the number of order product is equal to or more than a predetermined reference value.

When it is determined that it is required to order the product, the controller may be configured to control the user interface so that the user interface outputs a order requirement notification information which indicates that it is required to order the product.

The user interface may be configured to output the order requirement notification by flashing or changing the color or the size of the immediate order icon corresponding to the product that is required to be ordered.

The communicator may be configured to receive a order request signal of a product, which is needed for other home appliance among a plurality of home appliances, from the management server managing the plurality of home appliances.

When the user's selection related to the at least one immediate order icon is received, the user interface may be configured to display a pop-up window indicating that the product corresponding to the selected at least one immediate order icon is added to a order wish list.

The user interface may be further configured to display a order command button for purchasing at least one product contained on the order wish list.

The user interface configured to display the order command button according to the sales server.

The controller configured to generate order information for ordering at least one product contained on the order wish list, when the order button is selected.

The communicator configured to transmit the order information to a sales server corresponding to the selected order command button.

The product configured to comprise at least one of a filter used in a refrigerator, a filter used in an air conditioner, and a filter used in an air cleaner, foods stored in a refrigerator and detergent used in a washing machine.

When at least one of the filter of the refrigerator, the filter of the air conditioner and the filter of the air cleaner is ordered, the controller configured to provide a replacement guide screen for the filter to the user interface for a predetermined period of time or until it is confirmed that the filter is replaced.

In accordance with another aspect of the present disclosure, a control method of a home appliance comprises: displaying at least one immediate order icon, on a display, to order at least one product corresponding to the displayed at least one immediate order icon immediately when the at least one immediate order icon is selected, generating order information to order a product corresponding to the selected at least one immediate order icon, when the user's selection related to the at least one immediate order icon is received; and transmitting the generated order information to a sales server which processes an order of the product corresponding the selected at least one immediate order icon based on the generated order information.

The generation of the order information may be configured to comprise generating the order information based on information related to the product corresponding to the selected at least one immediate order icon, shipping information of the user and payment information about a payment method used for purchasing the product.

The control method may further comprise: accessing the sales server which processes an order of the product corresponding the selected at least one immediate order icon when the user's selection related to the at least one immediate order icon is received; and displaying a screen provided from the sales server.

The control method may further comprise: transmitting an order signal for ordering the product corresponding to the selected at least one immediate order icon, together with the order information to the sales server.

The control method may further comprise: displaying a order confirmation screen to receive an input of the confirmation of the order from the user based on the order information.

The control method may further comprise: when a order button displayed on the order confirmation screen is selected, transmitting a order signal for purchasing the product corresponding to the selected at least one immediate order icon, to the sales server, by the communicator.

The control method may further comprise: transmitting a order signal for purchasing the product corresponding to the selected at least one immediate order icon, together with the order information to the sales server, by the communicator.

The control method may further comprise: displaying a order completion confirmation screen which indicates that the order based on the order information is completed.

The control method may further comprise: receiving a order request signal of a product, which is needed for other home appliance among a plurality of home appliances, from a management server which manages the plurality of home appliances.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a control block diagram of a home appliance according to an embodiment of the present disclosure.

FIG. 2 is a view illustrating an appearance of a refrigerator according to an embodiment.

FIG. 3 is a view illustrating the front of the refrigerator according to an embodiment.

FIG. 4 is a control block diagram illustrating a configuration of a home appliance according to an embodiment in detail.

FIG. 5 is a view illustrating a configuration of the user interface.

FIG. 6 is a view illustrating a screen displayed on the display included in the refrigerator according to an embodiment.

FIGS. 7 and 8 views illustrating an example of immediate order icon on the display.

FIG. 9 is a view illustrating an online order screen displayed when the immediate order icon is selected.

FIG. 10 is a view illustrating an example of an icon displayed after the order of the filter is completed, in the refrigerator according to an embodiment.

FIG. 11 is a view illustrating an example of a filter replacement guide screen displayed on the display of the refrigerator according to an embodiment.

FIGS. 12 and 13 are views illustrating other example of a screen for guiding the replacement of the filter.

FIG. 14 is a view illustrating an example of a management server account login screen displayed on the refrigerator.

FIG. 15 is a control block diagram illustrating a mobile device connected to the refrigerator via the management server.

FIG. 16 is a view illustrating an example of a management server account login screen displayed on the mobile device.

FIGS. 17 to 21 are a view illustrating a generation process of the icon based on the order of the product using the refrigerator and the order history of the product.

FIGS. 22 and 23 are views illustrating an example of screen displayed when a user selects the immediate order button.

FIG. 24 is a view illustrating another example of a screen on which the immediate order icon is displayed.

FIG. 25 is a view illustrating another example of a screen displayed when the immediate order icon is selected in FIG. 24.

FIGS. 26 and 27 are views illustrating another example of a screen displayed when a order command button is selected in FIG. 24

FIGS. 28 to 31 are views illustrating a flow of inputting information by a user in order to monitor a state of foods stored in the refrigerator according to an embodiment of the present disclosure.

FIG. 32 is a view illustrating another example of a screen for inputting information related to expiration date of food stored in the refrigerator.

FIG. 33 is a view illustrating an example of a screen providing information related to a product needed to be ordered.

FIG. 34 is a view schematically illustrating a relationship among a plurality of home appliances which are connected to each other via a server.

FIG. 35 is a control block diagram schematically illustrating a washing machine and a refrigerator which are connected to each other via a server.

FIG. 36 is a view illustrating a screen to order a product for the washing machine using a user interface of the refrigerator.

FIG. 37 is a control block diagram illustrating a mobile device connected to the management server.

FIG. 38 is a view illustrating a method of outputting a notification to the mobile device.

FIGS. 39 and 40 are views illustrating an example of a screen when a product related to home appliances is ordered via the mobile device.

FIG. 41 is a flowchart illustrating generating and displaying the immediate order icon in a control method of the home appliance according to an embodiment of the present disclosure.

FIG. 42 is a flowchart illustrating another example of a method of purchasing a product by selecting the immediate order icon in the control method of the home appliance according to an embodiment of the present disclosure.

FIG. 43 is a flowchart illustrating a method of outputting a notification about whether to order a product in the control method of the home appliance according to an embodiment of the present disclosure.

### DETAILED DESCRIPTION

Embodiments described in the present disclosure and configurations shown in the drawings are merely examples of the embodiments of the present disclosure, and may be modified in various different ways at the time of filing of the present application to replace the embodiments and drawings of the present disclosure.

Also, the terms used herein are used to describe the embodiments and are not intended to limit and/or restrict the present disclosure.

The singular forms “a,” “an” and “the” are intended to include the plural forms as well, unless the context clearly indicates otherwise.

In this present disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, but elements are not limited by these terms. These terms are only used to distinguish one element from another element.

In the following description, terms such as “unit”, “block”, “member” and “module” indicate a unit for processing at least one function or operation. For example, the term may represent a software element or a hardware element, such as a Field Programmable Gate Array (FPGA) or an Application Specific Integrated Circuit (ASIC), and the module may perform a predetermined role.

Hereinafter the same reference numerals or signs shown in the drawings of the present disclosure indicate elements or components performing substantially the same function.

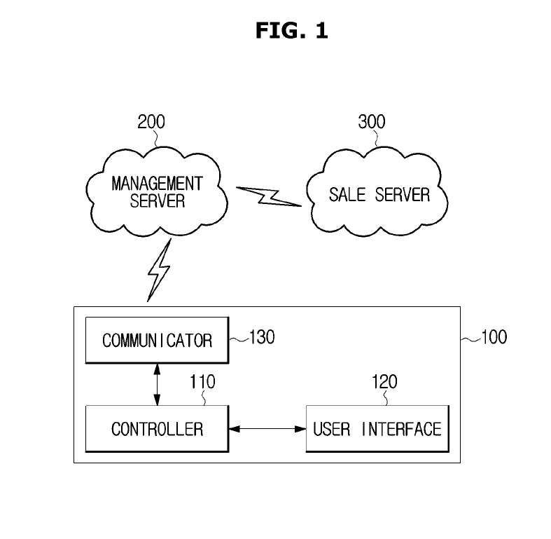

FIG. 1 is a control block diagram of a home appliance according to an embodiment of the present disclosure.

Referring to FIG. 1, according to an embodiment, a home appliance 100 includes a communicator 130 allowing the home appliance 100 to communicate with an external device, a user interface 120 outputting information to a user and receiving a command from a user, and a controller 110 controlling an operation of the home appliance 100.

The communicator 130 may transmit or receive data to or from an external device under the control of the controller 110. For example, the communicator 130 may communicate with a management server 200 to transmit information related to the home appliance to the management server 200 and the management server 200 may collect the information related to the home appliance to generate data that is needed for managing the home appliance.

An account for the connection to the management server 200 may be assigned to each user, and when a user accesses the assigned account, the user may control the home appliance 100 via the management server 200 or receive information for the management of the home appliance 100.

The management server 200 may be connected to an external server providing services to connect the home appliance 100 to the external sever. For example, the management server 200 may be connected to a sales server 300 which processes an order of products on-line to interconnect the home appliance 100 and the sales server 300. When the home appliance 100 and the sales server 300 are interconnected, a user may use services provided by the sales server 300 via the home appliance 100.

The user interface 120 may be provided in the home appliance 100 to receive a user input. The user interface 120 may output feedback about the input from the user and information needed for the user. The user interface 120 may provide information to the user by displaying a graphical user interface and simultaneously guide the user's input.

The controller 110 controls the user interface 120 so that the user interface 120 displays a graphical user interface based on information e.g., a state of the home appliance 100 and a purchasing history of the user. For example, the controller 110 may determine products for the corresponding home appliance or other home appliance, e.g., products for the use or the maintenance and repair of the home appliance, and the controller 110 may control the user interface 120 so that the user interface 120 may inform a user about that it is required to order the product or the user interface 120 may display a graphical user interface for guiding the order of the product.

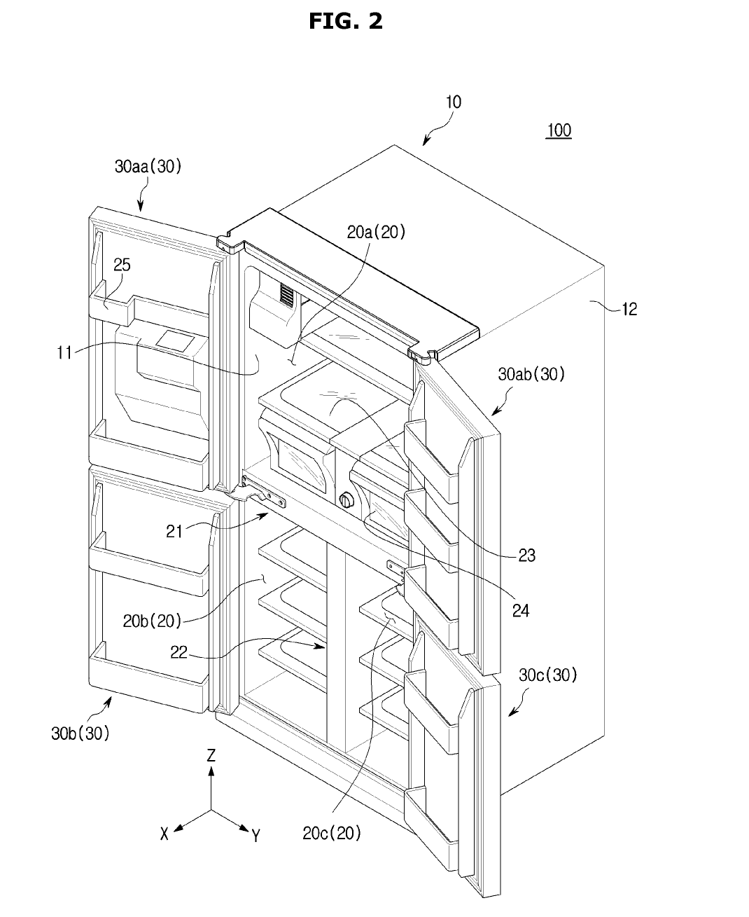

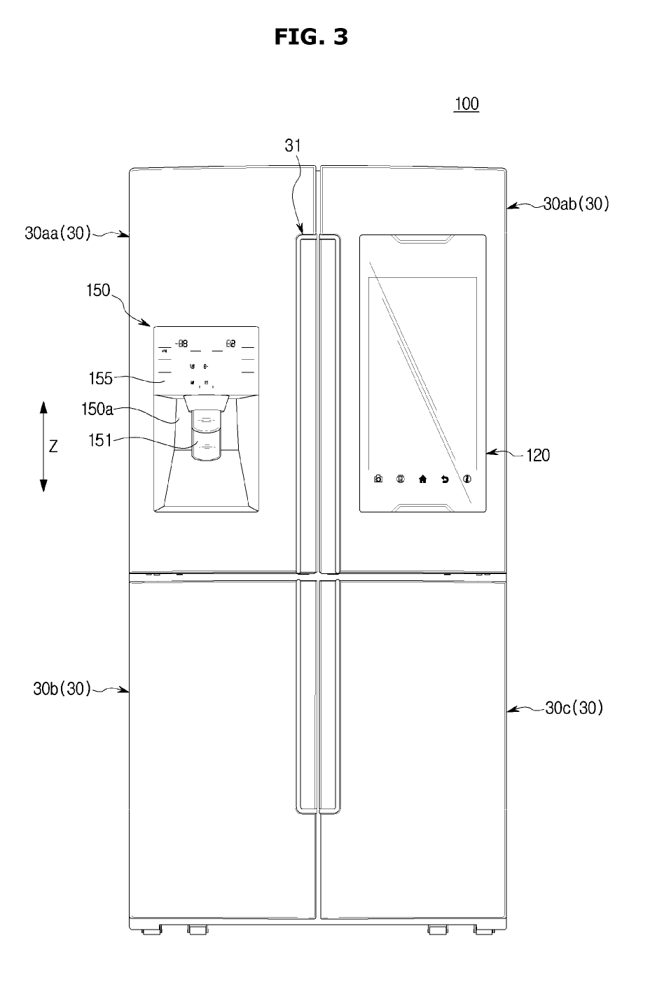

FIG. 2 is a view illustrating an appearance of a refrigerator according to an embodiment, and FIG. 3 is a view illustrating the front of the refrigerator according to an embodiment.

As shown in FIGS. 2 and 3, a refrigerator 100 may include a body 10 whose inner space is empty to form a storage compartment 20 and whose front surface is open, and a door 30 provided in the front side of the body 10 to open and close the storage compartment 20.

The body 10 forms an appearance of the refrigerator 100. The body 10 may include an inner case 11 forming the storage compartment 20 and an outer case 12 forming the appearance of the refrigerator 100 by being coupled to the outside of the inner case 11. An insulation material (not shown) may be foamed between the inner case 11 and the outer case 12 to prevent cool air of the storage compartment 20 from being leaked.

The storage compartment 20 may be divided into a plurality of spaces by a horizontal partition 21 and a vertical partition 22. For example, as illustrated in FIG. 2, the storage compartment 20 may be divided into an upper storage compartment 20a, a first lower storage compartment 20b, and a second lower storage compartment 20c.

In the storage compartment 20, shelves 23 on which foods are provided and a sealed container 24 storing foods in a sealed manner may be provided.

The upper storage compartment 20a may be opened or closed by a first upper door 30aa and a second upper door 30ab, and the first lower storage compartment 20b may be opened or closed by a first lower door 30b. The second lower storage compartment 20c may be opened or closed by a second lower door 30c.

A handle 31 may be provided in the door 30 to allow a user to easily open and close the door 30. The handle 31 may be formed to elongate in a vertical direction along between the first upper door 30aa and the second upper door 30ab, and between the first lower door 30b and the second lower door 30c. Therefore, when the door 30 is closed, it may be shown that the door 30 and the handle 31 are integrally formed.

Referring to FIG. 3, a dispenser 150 may be provided in the first upper door 30aa and the user interface 120 may be provided in the second upper door 30ab. Alternatively, the user interface 120 may be provided in the first upper door 30aa and the dispenser 150 may be provided in the second upper door 30ab.

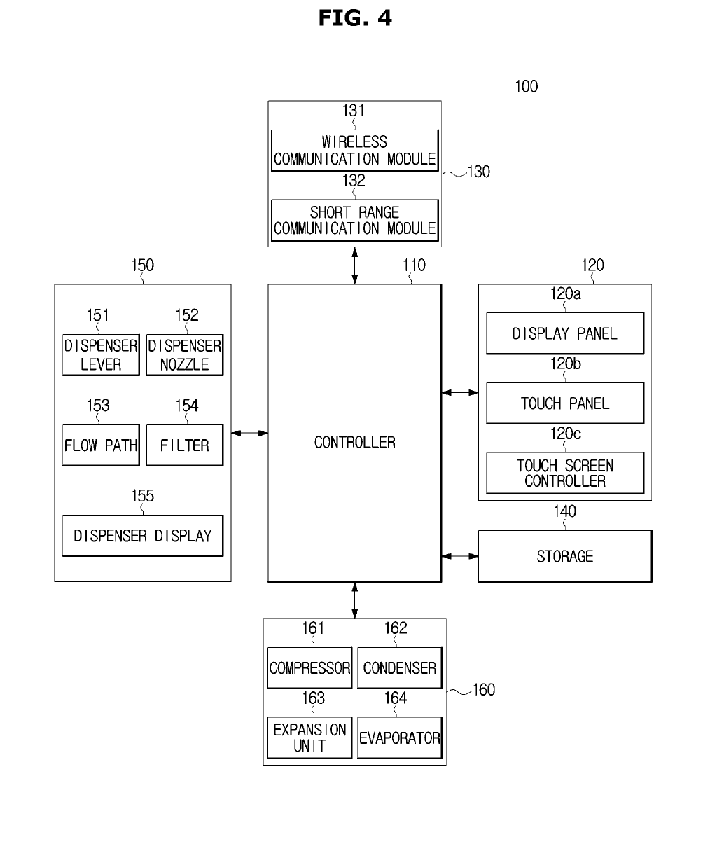

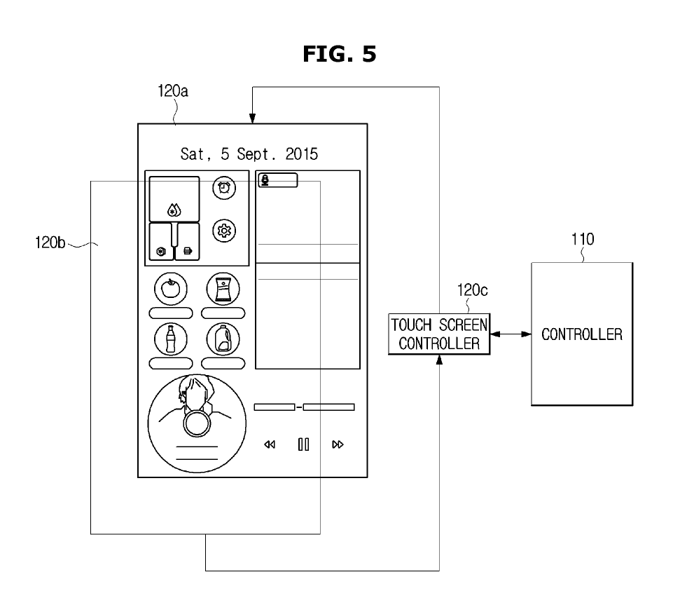

FIG. 4 is a control block diagram illustrating a configuration of a home appliance according to an embodiment in detail, and FIG. 5 is a view illustrating a configuration of the user interface.

According to an embodiment, the home appliance 100 may include a refrigerator, an air conditioner, a washing apparatus, an air cleaner, an oven, a microwave oven, a robot cleaner, and a television. However, the embodiment of the home appliance 100 is not limited thereto and thus any home appliance may be the home appliance 100 as long as having a user interface to be connected to a server via a communication device.

However, in the following embodiments, it is assumed that the home appliance 100 is a refrigerator for illustrative purposes. Hereinafter, the home appliance 100 will be referred to as a refrigerator 100.

Referring to FIG. 4, the communicator 130 may include one or more communication modules 131 and 132 for transmitting and receiving data according to a predetermined protocol. For example, the communicator 130 may include a wireless communication module 131 and a short range communication module 132.

The wireless communication module 131 may include at least one of various communication modules connected to Internet network in a wireless communication system, e.g., WiFi , Wireless broadband (Wibro), Global System for Mobile Communication (GSM), Code Division Multiple Access (CDMA), Wideband Code Division Multiple Access (WCDMA), (Universal Mobile Telecommunications System (UMTS), Time Division Multiple Access (TDMA), Long Term Evolution (LTE), 4 generation mobile communication (4G), and 5 generation mobile communication (5G).

The short-range communication module 132 may include at least one of various short-range communication modules to transmit and receive a signal in a short range using a wireless communication system, e.g. Bluetooth module, infrared communication module, Radio Frequency Identification (RFID) communication module, Wireless Local Access Network (WLAN) communication module, NFC communication module, and Zigbee communication module.

The refrigerator 100 may communicate with the management server 200 and other external server via the wireless communication module 131 so as to send and receive a signal to and from the management server 200 and the other external server. The refrigerator 100 may send and receive a signal to and from other home appliance or a mobile device via the management server 200.

The refrigerator 100 may directly communicate with other home appliance and a mobile device using the short-range communication module 132.

The communicator 130 may include an antenna transmitting or receiving a radio signal to or from a free space and a modulator/demodulator modulating data to be transmitted or demodulating the received radio signal.

The user interface 120 includes a display outputting an image and an input device receiving a user input. For example, the user interface 120 may be implemented as a touch screen allowing an intuitive input of a user.

When the user interface 120 is implemented as a touch screen, the user interface 120 may include a display 120a displaying an image, a touch panel 120b receiving a user's input and a touch screen controller 120c controlling and driving the display 120a and the touch panel 120b.

The display 120a may convert image data, which is received from the controller 110 via the touch screen controller 120c, into an optical image seen by a user.

The display 120a may employ a cathode ray tube (CRT) display panel, a liquid crystal displays (LCD) panel, a light emitting diode (LED) panel, an organic light emitting diode (OLED) panel, a plasma display panel (PDP), and a field emission display (FED) panel. However, the type of the display 120a is not limited thereto, and thus any display may be the display 120a as long as capable of visually displaying an optical image corresponding to image data.

The touch panel 120b may detect a user's touch input and transmit an electrical signal corresponding to the detected touch input to the touch screen controller 120c.

Particularly, the touch panel 120b may detect a user's touch input and transmit an electrical signal corresponding to the coordinates of the user's touch point to the touch screen controller 120c. The touch screen controller 120c may obtain the coordinates of the user touch point based on the electric signal received from the touch panel 120b.

Referring to FIG. 5, the touch panel 120b may be located in front of the display 120a. In other words, the touch panel 120b may be provided on a surface on which an image is displayed. Therefore, the touch panel 120b may be formed of a transparent material so that the image displayed on the display 120a is not distorted.

The touch panel 120b may employ a resistive touch panel or a capacitive touch panel. However, the touch panel 120b is not limited thereto and thus various input means may be employed as the touch panel 120b as long as capable of detecting a touch or approach of a user and outputting an electrical signal corresponding to coordinates of the detected touch point or coordinates of the detected approach point.

The touch screen controller 120c may drive and control the operation of the display 120a and the touch panel 120b. Particularly, the touch screen controller 120c may drive the display 120a so that the display 120a displays an optical image corresponding to the received image data and may control the touch panel 120b so that the touch panel 120b detects the coordinates of the user's touch point.

According to embodiments, the touch screen controller 120c may determine the coordinates of the user's touch point based on the electrical signal output from the touch panel 120b and transmit the coordinates of the user's touch point to the controller 110.

According to embodiments, the touch screen controller 120c may transmit the electrical signal output from the touch panel 120b to the controller 110 so that the controller 110 determines the coordinates of the user's touch point.

The touch screen controller 120c may include a memory storing programs and data for controlling an operation of the display 120a and the touch panel 120b, and a microprocessor performing the calculation for controlling an operation of the display 120a and the touch panel 120b according to the program and data stored in the memory. The memory and the processor of the touch screen controller 120c may be integrated in a single chip or separated chips.

Referring again to FIG. 4, the refrigerator 100 may further include a storage 140 storing control programs and control data for controlling the operation of the refrigerator 100, information related to the refrigerator, various application programs and application data.

For example, the storage 140 may store operating system (OS) programs managing the configuration and the resources (hardware and software) included in the refrigerator 100, an image display application displaying previously stored images, a video play application playing a previously stored video, a scheduler application managing schedules, a memo application storing and displaying memo, and an online shopping application purchasing products on line.

The storage 140 may include a non-volatile memory in which program data is not lost even if power is turned off. For example, the storage may include a high-capacity flash memory or a semiconductor element drive (Solid State Drive; SSD).

In addition, the storage 140 may further include a volatile memory storing data temporarily. The volatile memory may temporarily store necessary data for data processing or calculation.

The refrigerator 100 may further include the dispenser 150 discharging water or ice. A user may be provided with water or ice via the dispenser 150 without opening the door 30.

The dispenser 150 may include a dispenser lever 151 receiving a water or ice discharging command from a user, a dispenser nozzle 152 discharging water or ice, a flow path 153 guiding water from an external water source to the dispenser nozzle 152, a filter 154 filtering water to be discharged and a dispenser display panel 155 displaying an operation state of the dispenser 150.

As illustrated in FIG. 3, the dispenser 150 may be installed in the first upper door 30aa. A cavity 150a may be formed in a recessed shape in the door 30 or the outer case 12 to make a discharging space of water or ice. In the cavity 150a, the dispenser nozzle 152 and the dispenser lever 151 may be provided. When a user presses the dispenser lever 151, water or ice may be discharged from the dispenser nozzle 152.

Particularly, when water is discharged through the dispenser nozzle 152, the water may flow to the dispenser nozzle 152 from an external water supply source (not shown) along the flow path 153. Also, the water may be purified by the filter 154, while flowing through the dispenser nozzle 152.

The filter 154 may be detachably installed in the body 10 or the door 30 and thus when the filter 154 reaches its end of life, the replacement of the filter 154 may be easily performed.

The refrigerator 100 may further include a cooler 160 for supplying cool air to the storage compartment 20. The cooler 160 may maintain a temperature of the storage compartment 20 in a certain range using the evaporation of the refrigerant.

The cooler 160 may include a compressor 161 compressing gaseous refrigerant, a condenser 162 changing the compressed gaseous refrigerant into liquid refrigerant, an expansion unit 163 depressing the liquid refrigerant, and an evaporator 164 changing the depressed liquid refrigerant to the gaseous state.

The cooler 160 may supply the cold air to the storage compartment 20 using the phenomenon that the depressed liquid refrigerant absorbs heat energy from the ambient air while being changed into the gas state.

However, the structure of the cooler 160 is not limited to the compressor 161, the condenser 162, the expansion unit 163 and the evaporator 164.

For example, the cooler 160 may include a peltier element using the Peltier effect. The Peltier effect means that heat is generated in one of the metals and endothermic phenomenon occurs in the other metal when a current flows through the contact surface where the different kind metals are in contact with each other. The cooler 160 may supply the cool air to the storage compartment 20 using the peltier element.

For another example, the cooler 160 may include a magnetic refrigeration device using the magneto-caloric effect. The magneto-caloric effect means that when a certain substance (magneto-caloric substance) is magnetized, it releases heat, and when a specific substance (magneto-caloric substance) is demagnetized, it absorbs heat. The cooler 160 may supply the cool air to the storage compartment 20 using the magnetic refrigeration device.

The controller 110 controls the user interface 120, the communicator 130, the storage 140, the dispenser 150, and the cooler 160.

For example, the controller 110 may control the user interface 120 so that the user interface 120 may display information related to products for the use or maintenance and repair of the refrigerator 100. The controller 110 may order products by connecting to the sales server 300 based on the user's input received via the user interface 120.

When the controller 110 controls the user interface 120 so that the user interface 120 displays information related to products for the use or maintenance and repair of the refrigerator 100, the controller 110 may use data stored in the storage 140 and data transmitted from the communicator 130.

The controller 110 may control the user interface 120 so that the user interface 120 may display information related to the state of the refrigerator 100 based on data received from the communicator 130 or data stored in the storage 140.

The controller 110 may control the dispenser 150 or the cooler 160 based on the user's input received by the user interface 120.

The controller 110 may include a microprocessor performing the calculation for the control of the refrigerator 100, and a memory storing and memorizing programs and data related to the calculation of the microprocessor.

The microprocessor may call the data stored/memorized in the memory according to the program stored/memorized in the memory, and perform the calculation on the called data. The microprocessor may output a result of the calculation in the memory.

The memory may include a volatile memory that loses the memorized data when power supply is stopped. The volatile memory may call the program and data from the above mentioned storage 140, and may temporarily memorize the called data.

Further, the volatile memory may provide the memorized programs and data to the microprocessor and may memorize the data output from the microprocessor. The volatile memory may include a SRAM, and DRAM.

In addition, the memory may also further include a non-volatile memory as needed. Non-volatile memory may store firmware for managing and initializing various components included in the refrigerator 100. The nonvolatile memory may include read-only memory (ROM), EPROM, EEPROM, and a flash memory.

The controller 110 may include a plurality of microprocessors and memories. For example, the controller 110 may include a first microprocessor and a first memory controlling the dispenser 150 and the cooler 160, and a second microprocessor and a second memory controlling the storage 140 and the communicator 130.

The microprocessor and memory has been described according to the function but it is not necessary to distinguish the microprocessor and memory according to the position. For example, a microprocessor and a memory may be implemented in a separate chip or integrated into a single chip.

The controller 110 may control the overall operation of the refrigerator 100 as well as the above mentioned operation. Unless stated otherwise, it may be assumed that the operation of the refrigerator 100 is performed under the control of the controller 110.

Hereinbefore it has been described that the controller 110, the storage 140, and the communicator 130 are distinguished according to the function but it is not necessary to distinguish that the controller 110, the storage 140, and the communicator 130 in a physical manner.

For example, the controller 110, the storage 140 and the communicator 130 may be integrally formed as a single chip or implemented as a separate chip. The controller 110, the storage 140 and the communicator 130 may share a processor or a memory.

Hereinbefore the user interface 120, the communicator 130, the storage 140, the dispenser 150 and the cooler 160 have been described as components of the refrigerator 100 but as needed, the refrigerator 100 may include a new component or exclude some components.

For example, the refrigerator 100 may further include a speaker acoustically outputting information to a user and a microphone receiving an input of the speaker via the voice. The refrigerator 100 may further include a temperature sensor detecting an internal temperature of the storage compartment 20.

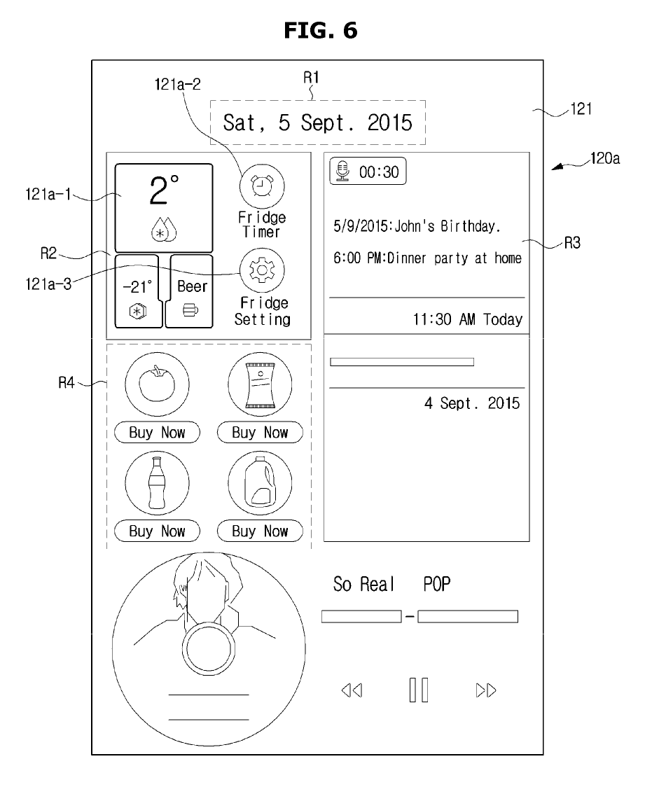

FIG. 6 is a view illustrating a screen displayed on the display included in the refrigerator according to an embodiment.

When the power is supplied to the refrigerator 100, the controller 110 may control the user interface 120 to display a home screen 121 as shown in FIG. 6.

For example, a time/date display region (R1) indicating the date and time, an operation information display region (R2) indicating the operation information of the refrigerator 100, and a schedule display region (R3) indicating schedule information stored by a user may be displayed on the home screen 121.

The current time information and current date information may be displayed on the time/date display region (R1). Weather information may be further displayed on the time/date display region (R1).

A storage compartment map 121a-1 related to an operation of the plurality of storage compartments 20a, 20b and 20c contained in the refrigerator 100 may be displayed on the operation information display region (R2).

Information related to the operation of the plurality of storage compartments 20a, 20b and 20c contained in the refrigerator 100 may be displayed on the storage compartment map 121a-1. For example, as shown in FIG. 6, on the storage compartment map 121a-1, the upper storage compartment 20a, the first lower storage compartment 20b, and the second lower storage compartment 20c may be displayed to be divided and a target temperature or a current temperature of the upper storage compartment 20a, the first lower storage compartment 20b and the second lower storage compartment 20c may be displayed.

When a user touches the region indicating the storage compartments 20a, 20b and 20c, the controller 110 may display Graphical User Interface (GUI) on a display 120a to set a target temperature of the storage compartments 20a, 20b and 20c each.

The GUI displayed on the display 120a may be configured with a variety of graphic objects, and the graphics objects may include a graphic object indicating certain information and a graphic object receiving a user's selection. The graphic object receiving a user's selection may include a button or an icon.

According to an embodiment, when the user interface 120 is implemented as a touch screen, a user's selection about the graphic object may be performed by touching or tapping the graphic object displayed on the user interface 120.

A timer setting icon 121a-2 and a refrigerator setting icon 121a -3 may be further displayed on the operation information display region (R2).

When the timer settings icon 121a-2 is selected by a user, a timer setting screen for setting a target time of the timer may be displayed on the display 120a. For example, a user may input a time to output an alarm and a time interval to output an alarm by using the variety of buttons or icons displayed on the timer setting screen. The refrigerator 100 may output an alarm at a time input by a user or at a time when a time interval input by a user is expired.

When the refrigerator settings icon 121a-3 is selected by a user, the controller 110 may display an operation setting screen to which a setting value is input to control an operation of the refrigerator 100, on the display 120a. For example, a user may set each target temperature of the upper storage compartment 20a, the first lower storage compartment 20b and the second lower storage compartment 20c contained in the refrigerator 100 and whether water or ice is discharged via the dispenser 150, by using the variety of graphic objects displayed on the operation setting screen.

The schedule information input by a user may be displayed on the schedule display region (R3). It may be possible to receive a user's schedule from an external server in cooperation with the external server that manages the schedule of the user.

An online shopping region (R4) for the online shopping via the refrigerator 100 may be displayed on the home screen 121. The online shopping region (R4) may provide information related to products for the use or maintenance and repair of the current refrigerator 100 to a user and the online shopping region (R4) may display a variety of icons and buttons to allow a user to intuitively select the order of the corresponding product. The icons and buttons displayed on the online shopping region (R4) will be described later in detail.

The view of FIG. 6 is merely an example of the home screen 121 displayed on the display 120a, and thus the refrigerator 100 may display a home screen having a variety of configurations according to the user's setting. The configuration of the home screen may be set or changed according to a user.

The user interface 120 may be provided with a wake up function that is automatically activated when a user accesses to a certain range. For example, when a user accesses to a certain range, the user interface 120 may be activated and turned on. In contrast, when a user escapes from the certain range, the user interface 120 may be inactivated and turned off.

When the user interface 120 is switched from an OFF state to an ON state, the home screen 121 may be displayed. A screen which is previously displayed before turned off may be displayed again.

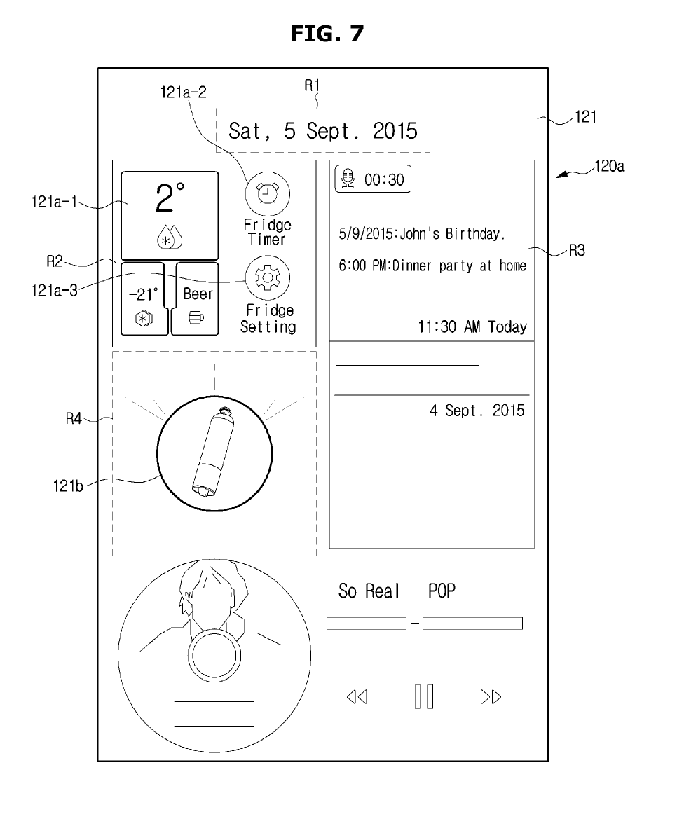

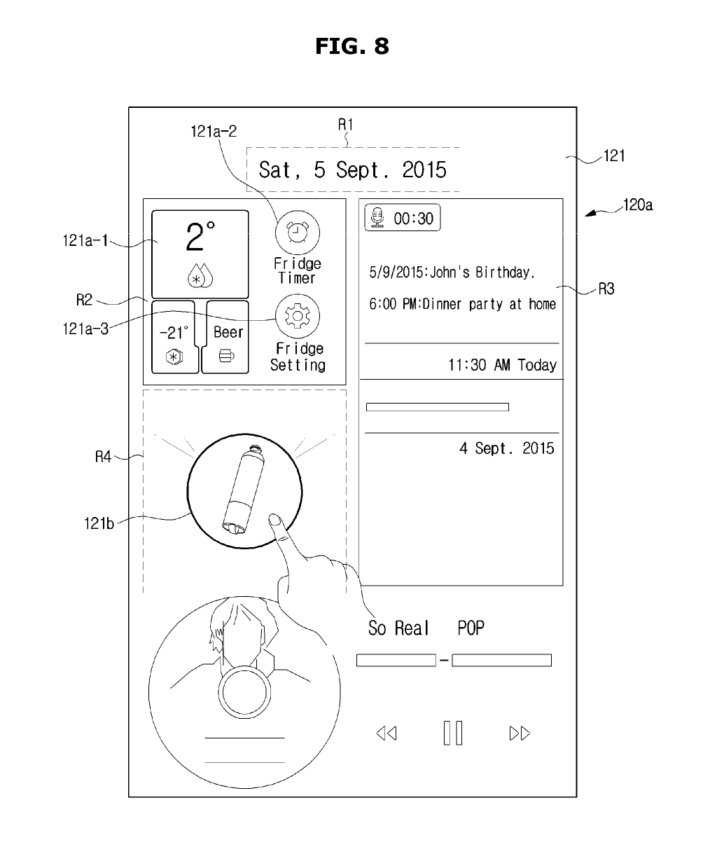

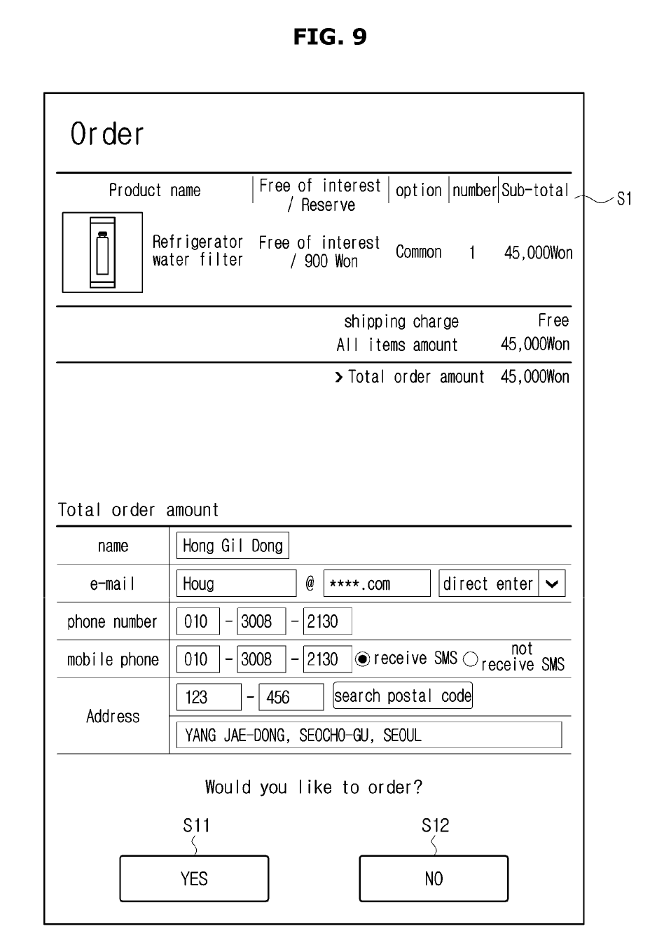

FIGS. 7 and 8 views illustrating an example of immediate order icon on the display, and FIG. 9 is a view illustrating an online order screen displayed when the immediate order icon is selected.

According to an embodiment, the refrigerator 100 may determine products for the use or maintenance and repair of the refrigerator 100 and display the immediate order icon to guide a user to immediately order the corresponding product, wherein the immediate order icon may include “buy it now” icon and “one click shopping” icon.

Particularly, when consumables for the maintenance and repair of the refrigerator 100 is needed to be replaced, the refrigerator 100 may indicate that the corresponding consumables is required to be replaced to a user while displaying the immediate order icon to allow the user to immediately order the corresponding consumables.

As described above, the refrigerator 100 discharges water or ice by having the dispenser 150. When discharging water or ice, the water or the ice may be purified through the filter 154. The filter 154 may correspond to consumables that are needs to be periodically replaced.

The controller 110 may determine a replacement time of the filter 154. For example, the controller 110 may recognize the replacement of the filter 154 and calculate the next replacement time based on a predetermined replacement period. Alternatively, a user may input whether to replace the filter 154. In addition, the management server 200 may manage the replacement time of the filter 154 and the management server 200 may transmit a filter replacement notification signal to the refrigerator 100 when it is time to replace the filter 154

When it is time to replace the filter 154, as illustrated in FIG. 7, the display 120a may output a notification indicating that the filter is needed to be replaced, by flashing the immediate order icon 121b of the filter. Alternatively, the display 120a may output the notification by changing the size or the color of the immediate order icon 121b, and thus there is no limitation in the notification output method.

Alternatively, the immediate order icon 121b may be displayed on the online shopping region (R4) regardless of the replacement time of the filter 154, and when it is time to replace the filter 154, the immediate order icon 121b may be used to output the filter replacement notification by changing the size or the color of the immediate order icon 121b or by flashing the immediate order icon 121b.

When it is not time to replace the filter 154, the immediate order icon 121b may be not displayed on the display 120a and only when it is time to replace the filter 154, the immediate order icon 121b may be displayed on the display 120a to output the filter replacement notification.

As illustrated in FIG. 8, a user may select the immediate order icon 121b by touching the immediate order icon 121b. When the immediate order icon 121b is selected, the display 121a may display a filter online order screen (S1) to order immediately a filter, as illustrated in FIG. 9.

Particularly, when a filter order command is input by selecting the immediate order icon 121b by a user, the controller 110 may transmit order information and order number about the corresponding filter, to the management server 200 via the communicator 130. The management server 200 may access to the sales server 300 selling the corresponding filter and link the refrigerator 100 with the sales server 300 selling the corresponding filter. That is, the refrigerator 100 may be automatically access to a site selling the corresponding filter through the management server 200.

The display 120a may display the filter online order screen (S1) provided from the sales server 300 selling the corresponding filter. The filter online order screen (S1) may be not an initial screen of the filter shopping site, but a screen which is displayed after the filter type is selected and user's shipping information and payment information are input.

In other words, on the online order screen (S1), the type and price of the filter used for the refrigerator 100 may be displayed while user's shipping information that is pre-registered is displayed. In addition, payment information that is pre-registered may be displayed. The user may confirm the displayed information and select an order button (S11) thereby confirming the order of the filter. When a user selects the order button (S11), the controller 110 may transmit a order signal to the sales server 300 so that the order is completed.

Therefore, a user may select the immediate order icon 121b displayed on the display 120a, and thus it may be possible to omit a process of directly accessing the filter shopping site, searching the filter type, selecting the filter, and inputting information, e.g., shipping information and payment information which is required for purchasing the filter.

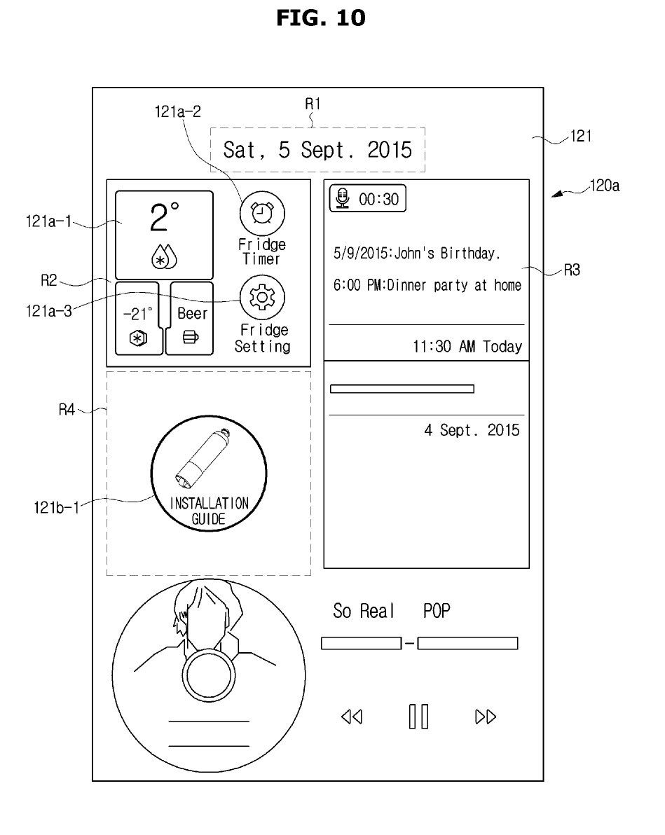

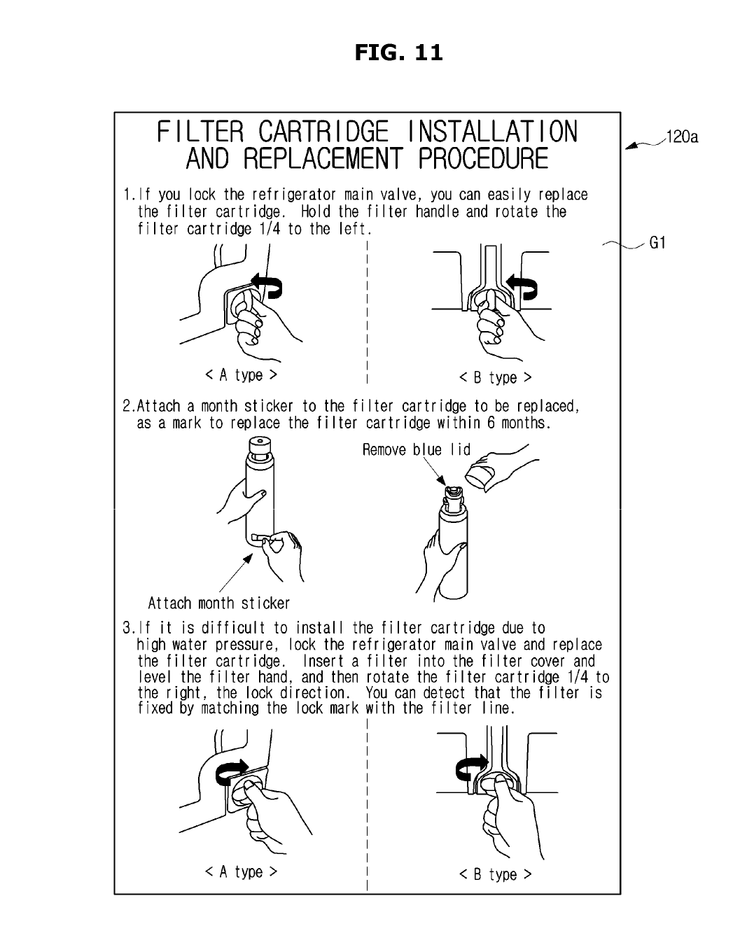

FIG. 10 is a view illustrating an example of an icon displayed after the order of the filter is completed, in the refrigerator according to an embodiment, and FIG. 11 is a view illustrating an example of a filter replacement guide screen displayed on the display of the refrigerator according to an embodiment.

When the order of the filter 154 is completed, the refrigerator 100 may provide information for guiding replacement of the filter 154 to a user. For example, the refrigerator 100 may display a screen for guiding replacement of the filter 154 on the display 120a until it is confirmed that the filter 154 is replaced or for a predetermined period after the order of the filter 154 is completed.

The replacement of the filter 154 may be checked by determining whether to replace the filter 154 by the controller 110, or by inputting information indicating that the filter 154 is replaced, to the user interface 120 by a user.

After the order of the filter 154 is completed, the immediate order icon 121b may be changed into a filter replacement guide icon 121b-1 indicating information for guiding the replacement of the filter, as illustrated in FIG. 10.

When a user selects the filter replacement guide icon 121b-1, a screen (G1) for guiding the replacement of the filter may be displayed on the display 120a, as illustrated in FIG. 11.

The screen (G1) for guiding the replacement of the filter may include an image, a text and a video. In addition, it may be possible to provide voice information via the speaker.

When the predetermined period is expired or when the replacement of the filter 154 is checked, the filter replacement guide icon 121b-1 may return to the immediate order icon 121b that is the shape before the order of the filter.

The immediate order icon 121b of the filter may be deleted or inactivated on the online shopping region (R4) of the home screen 121. In addition, the color of the immediate order icon 121b may be changed into a black and white to indicate the inactivation.

In this case, when it is time to replace the filter 154, again, the deleted filter immediate order icon 121b may be regenerated and displayed on the home screen 121, the inactivated filter immediate order icon 121b may be activated again, or the immediate order icon 121b in the black and white may have color again.

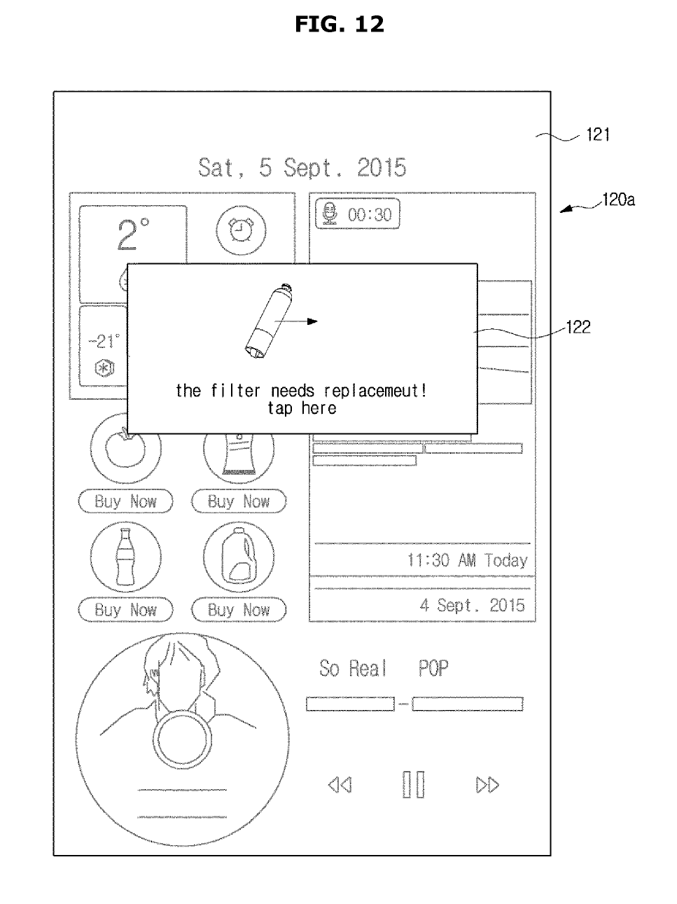

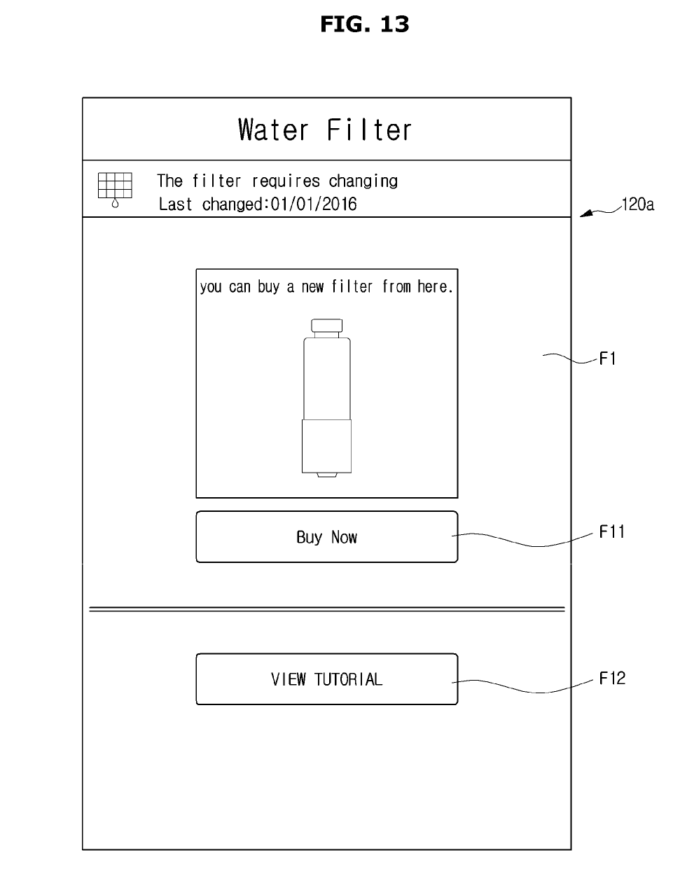

FIGS. 12 and 13 are views illustrating other example of a screen for guiding the replacement of the filter.

In the above example when it is time to replace the filter 154, the notification may be provided to a user by newly displaying the immediate order icon 121b or changing the immediate order icon 121b that is already displayed.

For another example, as illustrated in FIG. 12, a pop-up window 122 for the filter replacement notification may be displayed on the home screen 121. When a user touches or tapes the pop-up window 122, a filter check screen (F1) may be displayed to check a filter for the corresponding refrigerator, as illustrated in FIG. 13.

When a user selects an immediate order button (F11) displayed on the filter check screen (F1), the refrigerator 100 may automatically access to a order site of the corresponding filter and the display 120a may display the filter online order screen (S1) to order immediately a filter (refer to FIG. 9).

When a user selects a filter replacement guide button (F12) displayed on the filter check screen (F1), the display 120a may display the screen (G1) for guiding the replacement of the filter (refer to FIG. 11).

In this case, when the order of the filter 154 is completed, the filter replacement guide icon 121b-1 may be displayed on the home screen 121 for a predetermined period or until it is confirmed that the filter 154 is replaced. When a user selects the filter replacement guide icon 121b-1, the screen (G1) for guiding the replacement of the filter may be displayed on the display 120a.

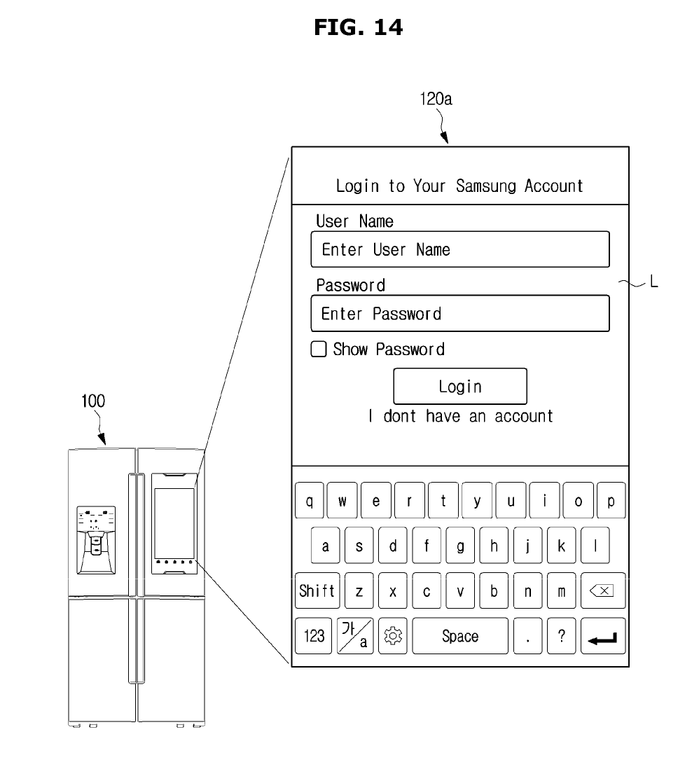

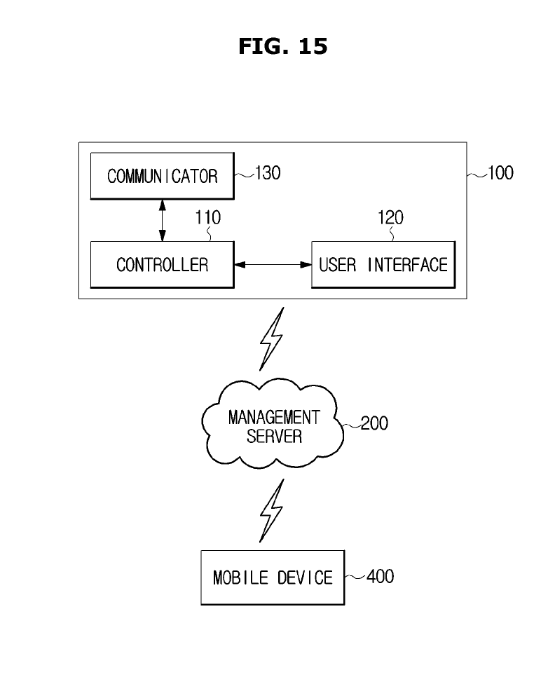

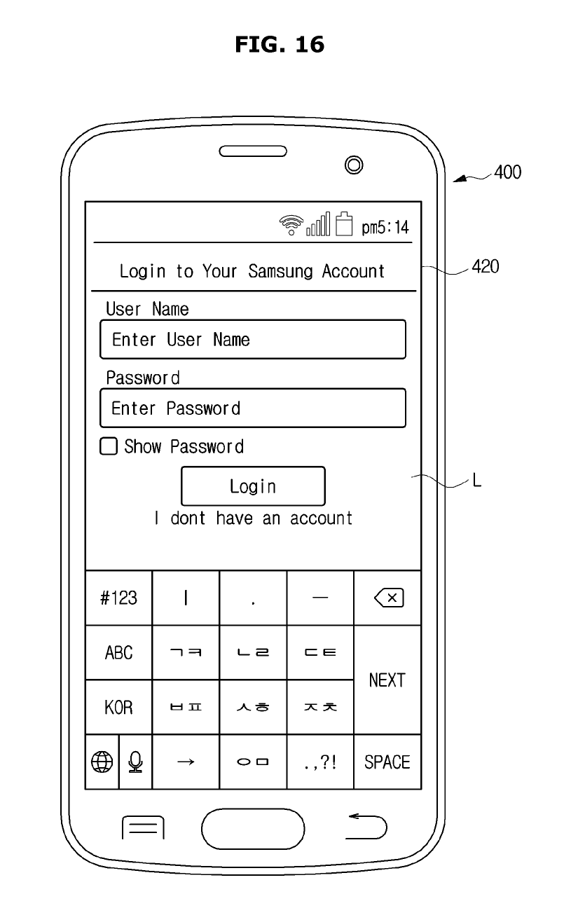

FIG. 14 is a view illustrating an example of a management server account login screen displayed on the refrigerator, FIG. 15 is a control block diagram illustrating a mobile device connected to the refrigerator via the management server, and FIG. 16 is a view illustrating an example of a management server account login screen displayed on the mobile device.

As described above, the management server 200 may integrally manage information related to home appliances and information related to a user so that the user orders products without inputting information related to consumables of the refrigerator 100 or user information at every time of online shopping.

An account of the management server 200 may be assigned to each user of the refrigerator 100 and the assigned account may be identified by identification (ID) or a username and a password. As illustrated in FIG. 14, a user may log in a management server account and access to the management server 200 by entering a predetermined ID and password on a login screen (L) on the display 120a.

When the refrigerator 100 is connected to the management server 200, the refrigerator 100 may be connected to other external device or the external server via the management server 200. When transmitting and receiving a signal to and from the other external device or the external server, the refrigerator 100 may use information stored and managed by the management server 200 and directly receive needed information from the management server 200.

Referring to FIG. 15, the mobile device 400 and the refrigerator 100 may be connected to each other via the management server 200. The mobile device 400 may include portable electronics, e.g., a smart phone, a smart watch, a smart glass, PDA and a table PC, wherein the portable electronics is provided with a user interface having a display and an input device and configured to transmit or receive a signal to or from an external device and an external server through a communication.

A user may download and install a home appliance management application in the mobile device 400 to manage home appliances, e.g., the refrigerator 100. When the home appliance management application is executed, as illustrated in FIG. 16, a login screen (L) may be displayed on a display 420 of the mobile device. The home appliance management application may be provided from the management server 200.

When a user enters a predetermined ID and password to the login screen (L) on the display 420 of the mobile device 400, the user may login the management server account. The management server 200 may manage a unique identifier that is assigned according to each refrigerator 100. Therefore, although the user logs in the management server account using the mobile device 400, a state in which the refrigerator 100 and the management server 200 are connected may be maintained.

That is, the refrigerator 100 may use information registered on the management server account when performing an online order, as long as the device, which is used for login the management server account, logs in the management server account, regardless of that the device is the home appliance or the mobile device 400.

Information related home appliances being used by a user and information related to a use may be registered in the management server account.

A user may directly enter information of the order (shipping information and payment information) after login the filter shopping site when the user initially orders a filter via the refrigerator 100. However, after the initial order, the user may order a filter using the information that is used in the initial purchase, without login or inputting additional information.

Alternatively, it may be possible to order a filter without login the filter shopping site or inputting information required for the order even when the user initially orders a filter in the refrigerator 100. Since the user pre-registers information required for the order of the filter, e.g, shipping information and payment information, in the management server account, the management server 200 may allow a user to enter the user information by transmitting the pre-registered information to the filter sales server even when a filter order signal is initially transmitted from the refrigerator 100.

When an operator of the filter sales server is identical to an operator of the management server, the login process on the filter shopping site may be omitted.

Although the operator of the filter sales server is different from the operator of the management server, it may be possible to link the login in the filter shopping site and the login in the management server account according to the contract between two operators.

In the above example, the filter 154 has been described as consumables of the refrigerator 100, but is not limited thereto. Therefore, the above mentioned embodiment may be applied to any component that is required to be replaced for the maintenance and repair of the refrigerator 100.

In addition, even if a component is not consumable that is needed to be periodically replaced, such as the filter 154, the above mentioned embodiment may be applied to the component when the component is needed to be replaced due to failure and breakage so that the user's immediate order may be performed.

The immediate order using the immediate order icon may be applied to other products other than a component of the refrigerator 100. A detail description thereof will be described

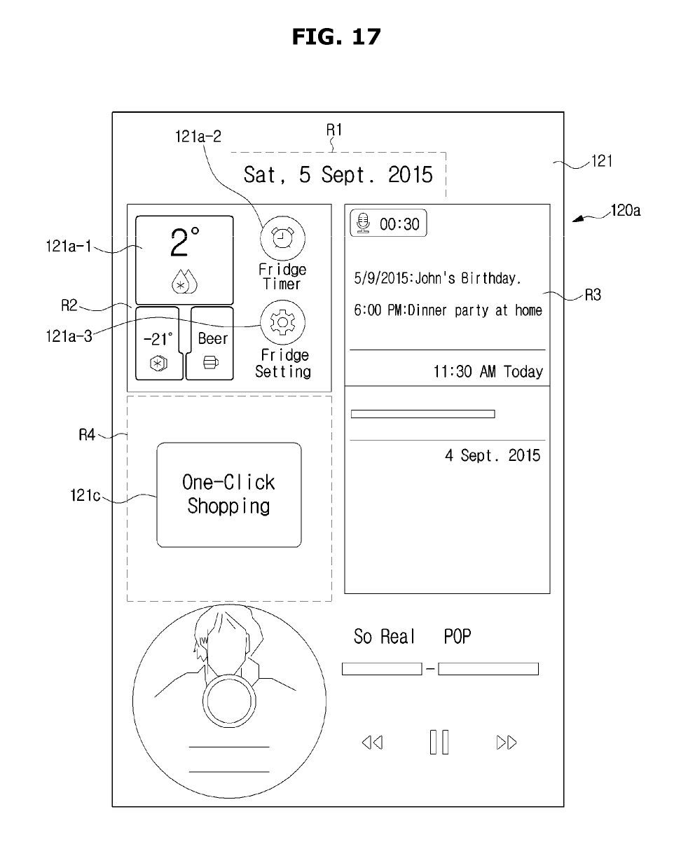

FIGS. 17 to 21 are a view illustrating a generation process of the icon based on the order of the product using the refrigerator and the order history of the product.

Referring to FIG. 17, a quick shopping icon 121c receiving a selection of an immediate order application may be displayed on the online shopping region (R4) of the home screen 121. “Immediate order application” may represent an application executing a series of operation that enables easy and quick shopping by minimizing an input from a user.

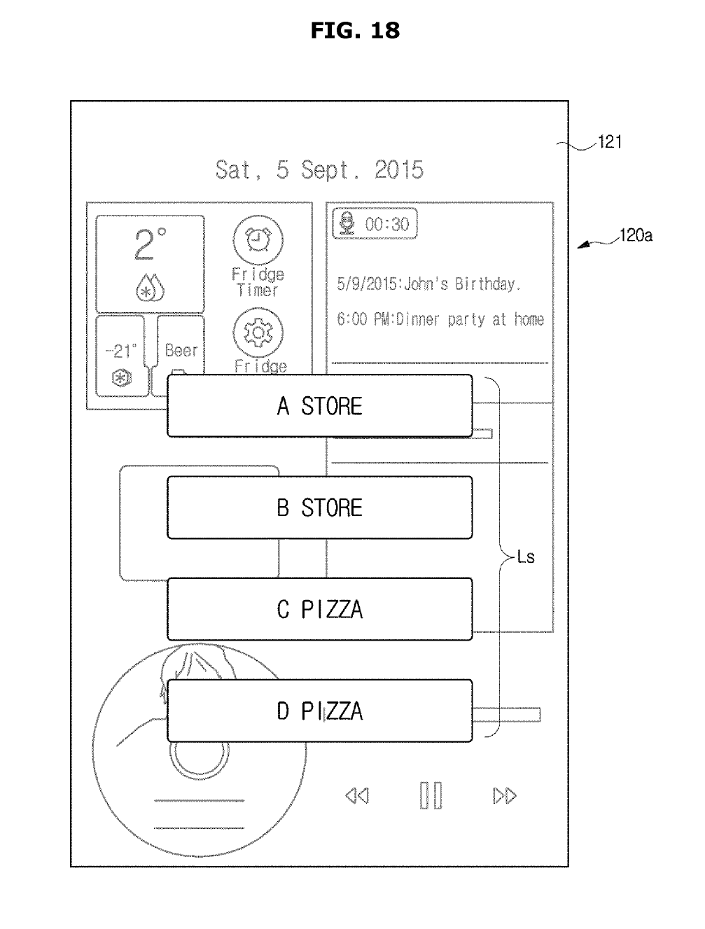

When a user selects the quick shopping icon 121c, a vendor list (Ls) may be displayed on the display 120a, as illustrated in FIG. 18. The vendors contained in the vendor list (Ls) may be determined by the contract between the operator of the management server 200 or the manufacturer/seller of the refrigerator 100 and the vendor.

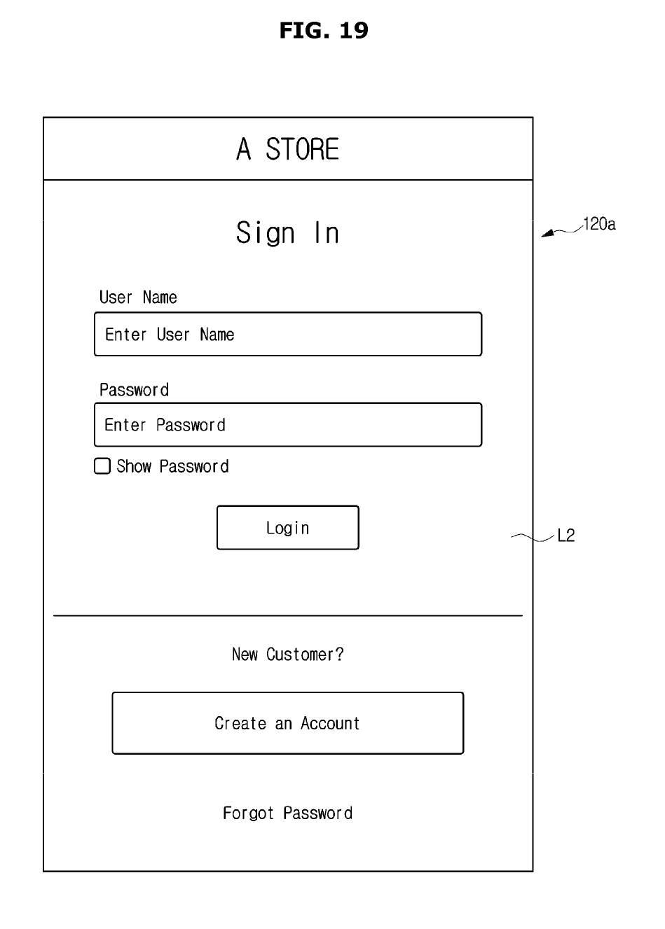

When a user selects any vendor in the vendor list (Ls), a screen (L2) for login an online shopping site of the selected vendor may be displayed on the display 120a, as illustrated in FIG. 19.

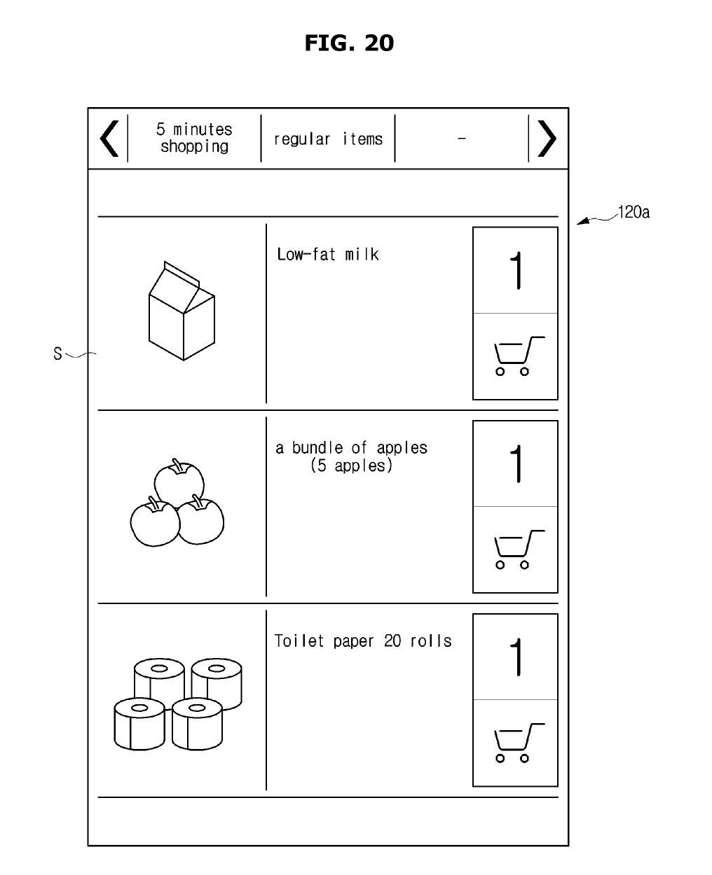

When a user logs in the corresponding site by entering the necessary information, selects a products to be ordered on the product selection screen (S), as illustrated in FIG. 20, and then the order is completed, the controller 110 may generate an immediate order icon 121d enabling a user to immediately order the product and display the immediate order icon 121d on the display 120a.

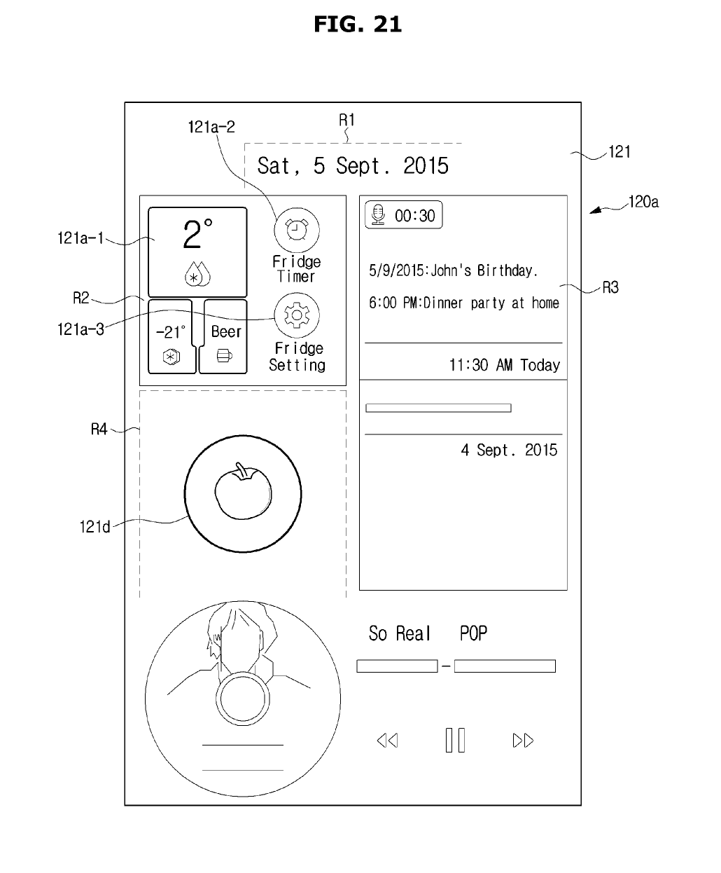

The immediate order icon 121d may be formed in an image or a text to represent information about the corresponding product and about the vendor of the corresponding product. For example, when the product is apples, the immediate order icon 121d may represent that the product is apples by having an image of an apple, as illustrated in FIG. 21.

In FIG. 21, only immediate order icon 121d is displayed but it may be possible to display two or more immediate order icons 121d according to the kind of the products ordered by a user.

Meanwhile, the immediate order icon 121d may be generated based on the number of times of the order of the product. As mentioned above, when the product is ordered once, the refrigerator 100 may generate the immediate order icon 121d about the corresponding product or alternatively only when the order is performed by more than a predetermined number of time (N times), the refrigerator 100 may generate the immediate order icon 121d about the corresponding product.

The number of times of the order may be counted according to the refrigerator 100, the account of the management server 200, or the account assigned to the online shopping site.

For example, the order via the home appliance 100 may be counted. The order via the mobile device 400 connected to the home appliance 100 via the management server 200 without using the home appliance 100 may be also counted. In addition, the order by logging in the online shopping site may be also counted regardless of whether the order is performed via the home appliance 100 or the mobile device 400.

It may be possible to control the generation and the display of the immediate order icon 121d in consideration with the size of the online shopping region (R4) of the home screen 121. For example, when the online shopping region (R4) has the size enough to display M immediate order icons 121d, it may be possible to generate the immediate order icon 121d and display the immediate order icon 121d until the number of the order which is ordered once or the number of the order which is ordered more than N times becomes M.

When the number of the products excesses M, it may be possible to delete the immediate order icon 121d about the product that is ordered by the least number of times or to delete the immediate order icon 121d about product in which the last order is the longest ago.

Information related to the product order history used for the generation of the immediate order icon 121d may be stored in the storage 140 or may be provided from the management server 200.

The controller 110 may generate immediate order information including information about the product, shipping information and payment information, and when a user selects the immediate order button, the controller 110 may transmit the immediate order information corresponding to the selected immediate order button, to the sales server 300.

Alternatively, the management server 200 may generate immediate order information including information about the product, shipping information and payment information, and when a user selects the immediate order button, the management server 200 may transmit the immediate order information corresponding to the selected immediate order button, to the sales server 300.

In addition, the immediate order information may be stored and managed in the sales server 300 according to the contract with the sales server 300, and when a user selects the immediate order button, the sales server 300 may order the corresponding product by itself based on the stored immediate order information.

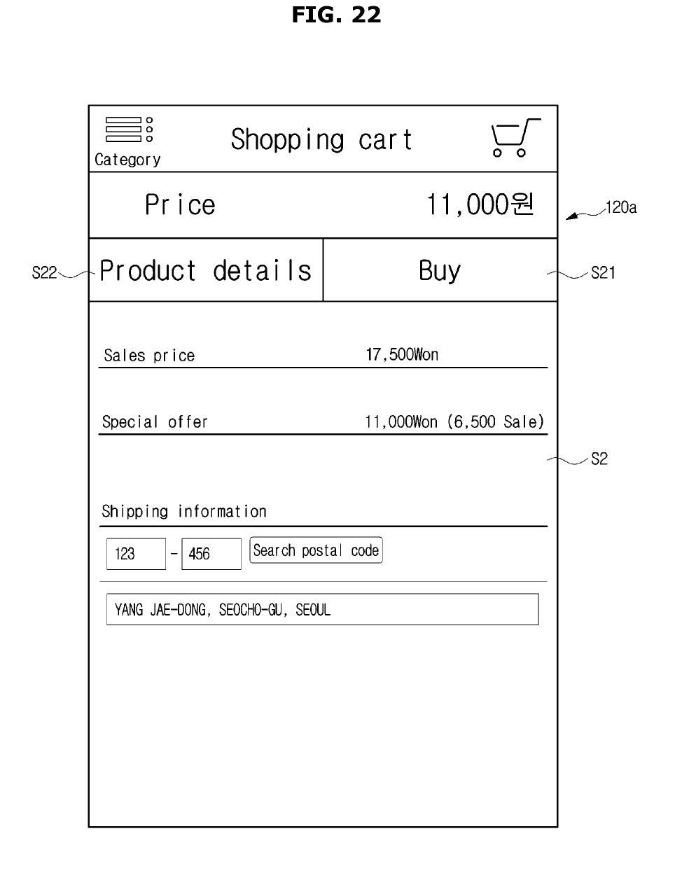

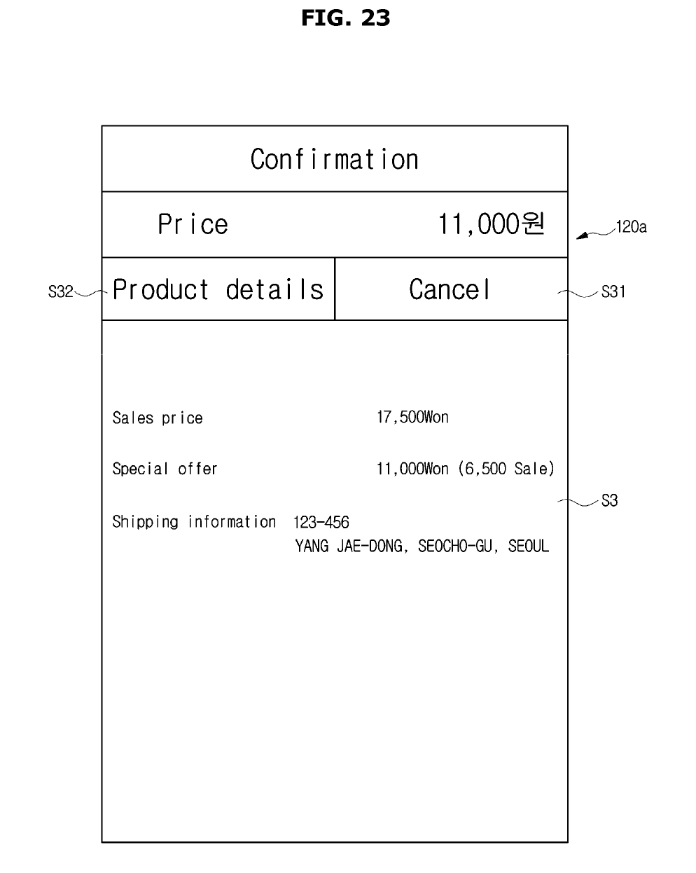

FIGS. 22 and 23 are views illustrating an example of screen displayed when a user selects the immediate order button.

When a user selects the immediate order icon 121d displayed on the display 120a, it is possible to automatically access an online shopping site corresponding to the immediate order icon 121d, and the corresponding product is automatically added to a order wish list and thus shipping information and payment information are automatically input. That is, on the online shopping site, login, searching and selecting product and inputting shipping information and payment information may be omitted.

As illustrated in FIG. 22, a order confirmation screen (S2), which is a previous step to complete the order of the product corresponding to the immediate order icon 121d may be displayed on the display 120a.

On the order confirmation screen (S2), the information related to the product, shipping and payment may be displayed, and when a user selects a order button (S21), the order of the corresponding product may be completed. When a user selects a product detail button (S22), detail information of the corresponding product may be displayed and thus the user may determine to order the product after checking the detail information.

According to the above mentioned example, when the immediate order icon 121d is generated and then displayed, a use may complete the order of the desired product with only two touches.

For another example, when a user selects the immediate order icon 121d, it may be possible to complete the order of the product corresponding to the immediate order icon 121d soon after the selection. As the above mentioned example, when receiving the final confirmation of user's order, a signal transmitted to the sales server 300 from the refrigerator 100 when selecting the immediate order icon 121d may correspond to a order signal about the corresponding product.

As an example described later, when the order is completed by selecting the immediate order icon 121d without receiving the final confirmation of user's order, a signal transmitted to the sales server 300 from the refrigerator 100 may correspond to a order signal about the corresponding product.

In this case, after the order of the product corresponding to the selected immediate order icon 121d is completed, a order completion confirmation screen (S3) may be displayed on the display 120a, as illustrated in FIG. 23.

On the order completion confirmation screen (S3), the information related to the ordered product, shipping and payment may be displayed. In addition, a product detail button (S32) for providing detail information of the product and a order cancel button (S31) for cancelling the order may be displayed.

For example, when the order information corresponding to the immediate order icon 121d does not match the information related to the product that a user wants to order, the user may select the order cancel button (S31) to cancel the order. When the order cancel button (S31) is not selected, the order of the corresponding product may be confirmed.

However, the screen illustrated in FIGS. 22 and 23 may be merely an example applied to the refrigerator 100, and thus a configuration of the screen may vary. For example, the immediate order icon 121d may indicate necessary information and there is not limitation in the shape thereof.

On the order confirmation screen (S2), the product detail button (S22) may be omitted, and on the order completion confirmation screen (S3), the order cancel button (S31) may be omitted.

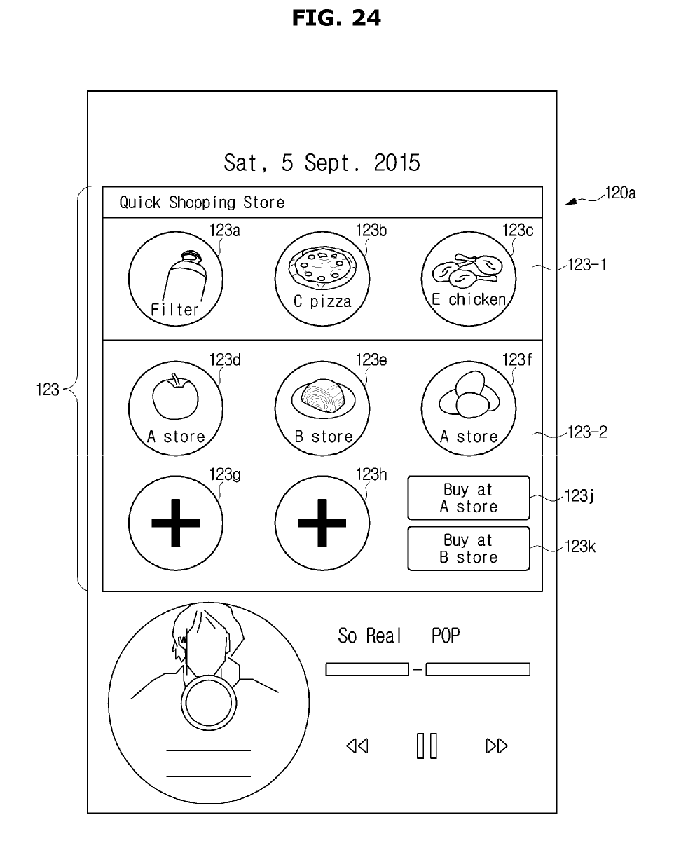

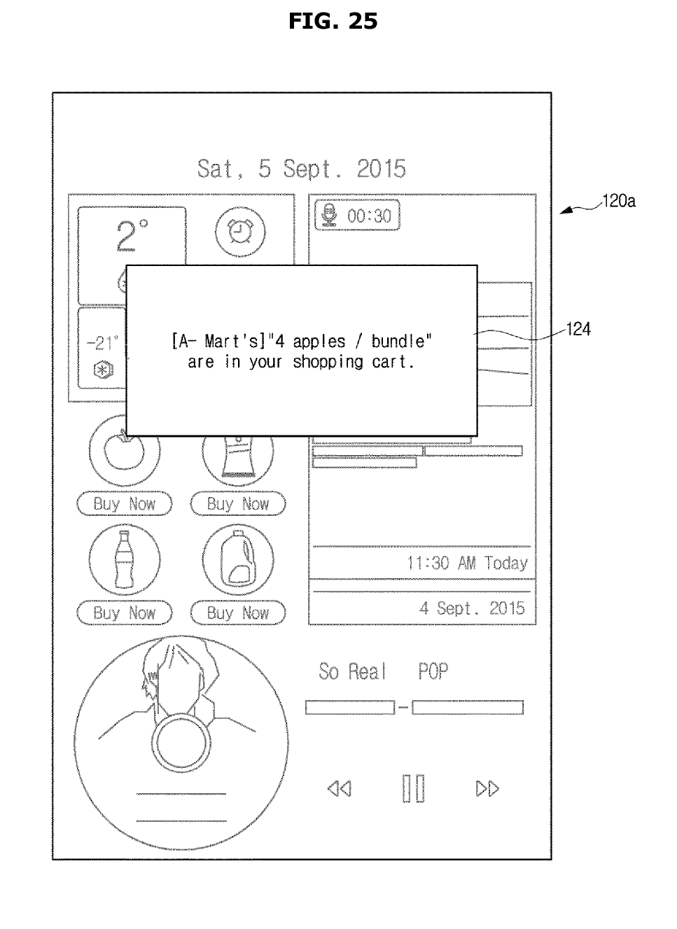

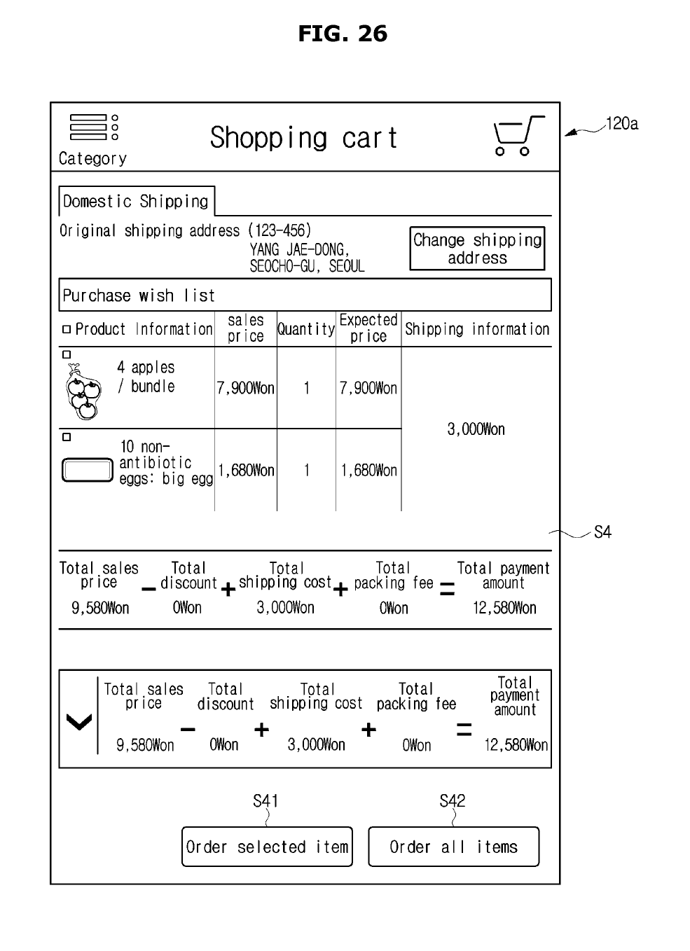

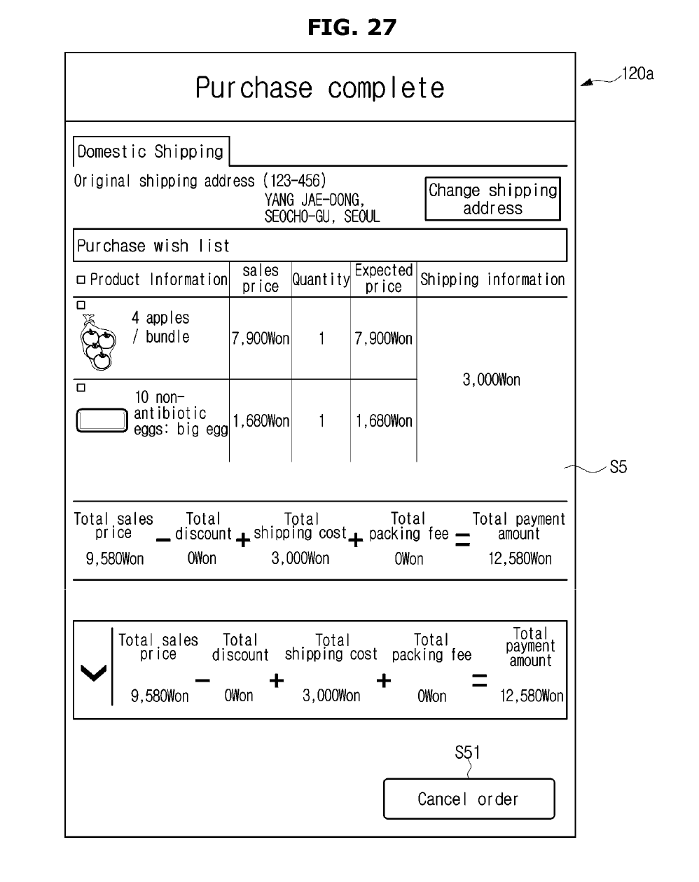

FIG. 24 is a view illustrating another example of a screen on which the immediate order icon is displayed, FIG. 25 is a view illustrating another example of a screen displayed when the immediate order icon is selected in FIG. 24, and FIGS. 26 and 27 are views illustrating another example of a screen displayed when a order command button is selected in FIG. 24

As mentioned above, FIG. 21 illustrates that the immediate order icon 121d is displayed on a region of the home screen 121, but alternatively the immediate order icon 121d may be displayed in a widget platform, as illustrated in FIG. 24.

Particularly, the display 120a may display an immediate order widget screen 123. On the immediate order widget screen 123, a vendor list 123-1 and an immediate order product list 123-2 may be displayed.

The vendor list 123-1 may include vendor selection icons 123a, 123b, and 123c for selecting a seller managing an online shopping site. The seller contained in the vendor list 123-1 may include a seller selling foods which is not stored in the refrigerator 100 and a seller selling house hold items which is not related to the refrigerator 100 as well as a seller selling a component for the maintenance and repair of the refrigerator 100, and a seller selling foods stored in the refrigerator 100.

In addition, although items are not foods or household items, a seller selling items that is available to buy online may be included in the vendor list 123-1. The seller contained in the vendor list 123-1 may be determined by a contract between the manufacturer and seller of the refrigerator 100 or the operator of the management server 200 and the seller.

When a user selects the vendor selection icons 123a, 123b, and 123c contained in the vendor list 123-1, it may be possible to access an online shopping site of a seller corresponding to the selected icon and a screen of the corresponding site may be displayed on the display 120a.

When there is a history in which the refrigerator 100 is accessed to the corresponding site to order a product, a process such as login, inputting shipping information, and inputting payment information may be not required. When a user selects a desired product, the shipping information and the payment information may be automatically input and thus the order may be completed when the user selects the order confirmation button.

Alternatively, it may be possible to automatically generate the order information about the product that is previously selected by a user. When a user wants to order another product, the order information previously generated may be changed.

As illustrated in FIG. 21, the immediate order product list 123-2 may include immediate order icons 123d, 123e and 123f generated based on the user's product order history.

For example, the immediate order product list 123-2 may include an immediate order icon 123d corresponding to an apple ordered in A store, an immediate order icon 123e corresponding to kimchi ordered in B store, and an immediate order icon 123f corresponding to an egg ordered in A store. The immediate order icons 123d, 123e and 123f each may guide a user's selection by indicating information about the corresponding product and information about a seller of the corresponding product.

As mentioned above, the immediate order icons 123d, 123e and 123f may be generated and displayed based on the number of times of the order of the corresponding product. Alternatively, the generation of the immediate order icons may be determined according to the kind of the products.

For example, when a user orders the product, such as apples, kimchi, and eggs, wherein the product does have a sub-menu which is considered, or although the sub-menu is present, the user does not consider the sub-menu, the immediate order icon may be generated and displayed according to the number of times of the order.

However, since there is a variety of sub menus when ordering a delivery food, such as chicken, pizza, and Chinese food, a user may consider a sub-menu (detail menu) when purchasing products. Therefore, it may be possible to allow a user to select a seller on the vendor list 123-1 and to select a specific menu on an online shopping site rather than generating the immediate order icon about each product.

However, the embodiment of the refrigerator 100 is not limited thereto. It may happen that the same menu is selected according to user's preference. Therefore, it may be possible to generate and display the immediate order icon of the corresponding product when the number of times of the order of the same menu is equal to or more that a predetermined times. That is, it may be possible to generate and display the immediate order icon according to the number of times of the order regardless of the type of the product.

Alternatively, a user may directly add the immediate order icon. As illustrated in FIG. 24, the immediate order product list 123-2 may include a product add icon 123g and 123h. When a user selects the product add icon 123g and 123h, the controller 110 may generate and display an immediate order icon for a product having no order history or having the number of times of the order less than a predetermined order number of times.

When a user selects one of the immediate order icons 123d, 123e and 123f, an order signal about the product corresponding to the selected immediate order icon may be transmitted to the sales server of the seller corresponding to the selected immediate order icon. According to the transmitted order signal, the product may be added to the order wish list. That the product is added to the order wish list may be illustrated by an image in which the product is stored in a shopping cart.

As mentioned above, an order confirmation pop-up 124 may be displayed on the display 120a to conform the order information, as illustrated in FIG. 25. The order information may include the seller information and the product information.

The order confirmation pop-up 124 may be disappeared when a predetermined time is expired. Alternatively, a confirmation button (not shown) may be displayed in the order confirmation pop-up 124 and then when a user selects confirmation button, the order confirmation pop-up 124 may be disappeared.

The selection of the immediate order icons 123d, 123e and 123f may not sufficient to transmit an order signal to the sales server, but it may be possible to transmit an order signal to the sales server when the order command button 123j and 123k is selected after the order list is stored in the storage 140 according to the selection of the immediate order icon 121d.

Referring again to FIG. 24, the immediate order product list 123-2 may further include the order command button 123j and 123k for purchasing the product that is added to the order wish list. The order command button 123j and 123k may be displayed according to the seller. For example, the order command button 123j for A store and the order command button 123k for B store may be separately displayed.

When a user selects the order command button 123j and 123k, it may be possible to automatically access an online shopping site of the seller corresponding to the selected order command button, and as illustrated in FIG. 26, a order confirmation screen (S4) indicating the order wish list may be displayed on the display 120a.

At least one product that is added by selecting the immediate order icons 123d, 123e and 123f by a user may be included in the order wish list, and the order confirmation screen (S4) displaying the order wish list may be displayed with the product information and the shipping information.

The user may complete the order of the selected product by selecting only some of the products included in the order wish list and by selecting an order selected product button (S41). It is also possible to complete the order of all products by selecting an order all products button (S42).

In this case, on the online shopping site of the seller, a process such as login, inputting shipping information, and inputting payment information may be omitted, and thus a user may complete the order of the product by only selecting the order button (S41 and S42).

Alternatively, when a user selects any one of the order command button 123j and 123k, it may be possible to automatically access the sales server 300 of the corresponding seller and to transmit a order signal about the product contained in the order wish list to the sales server 300.

As illustrated in FIG. 27, a order completion confirmation screen (S5) which is after the order of the product is completed may be displayed on the display 120a.

On the order completion confirmation screen (S5), information related to the ordered product, shipping and payment may be displayed. In addition, a order cancel button (S51) for canceling the order may be displayed.

For example, when the product contained in the order wish list does not match a product which the user wants to buy, the user may cancel the order by selecting the order cancel button (S51). When the order cancel button (S51) is not selected, the order of the corresponding product may be confirmed.

According to the embodiment of FIGS. 24 to 27, a user may select the immediate order icons 123d, 123e and 123f to add a desired product to the order wish list and then select the order command button 123j and 123k according to the seller to complete the order of the product that is added to the order wish list. Therefore, the user may order products that are sold by the same seller at once, and receive the product at once.

Meanwhile, the refrigerator 100 may actively provide information related a product that is needed to be ordered. For example, when the controller 110 monitors a state of foods stored in the refrigerator 100 and determines that a certain food is needed to be ordered, the controller 110 may inform that the corresponding food is required to be ordered, on the display 120a. Hereinafter a detail description thereof will be described with reference to drawings.

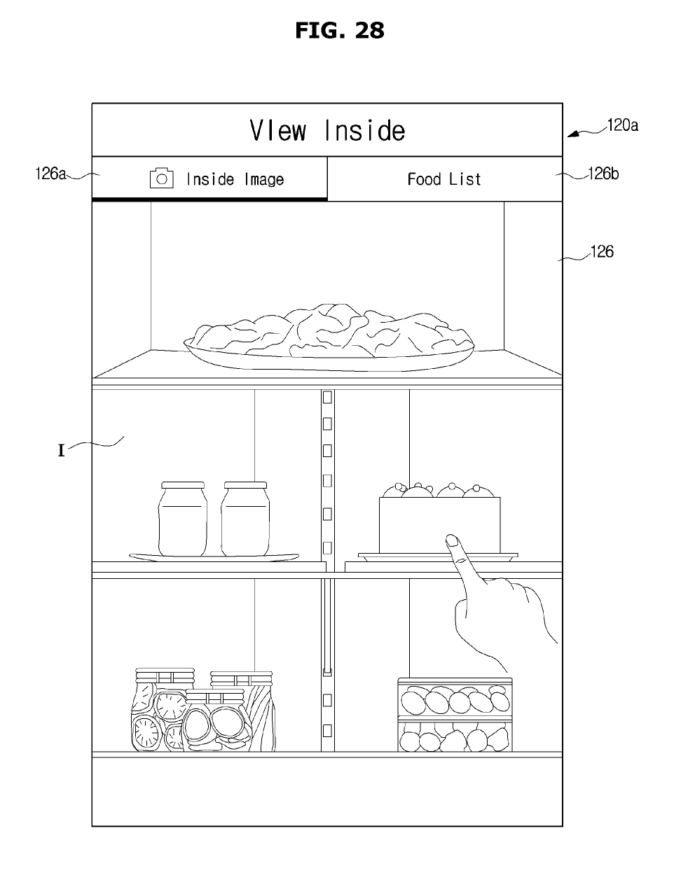

FIGS. 28 to 31 are views illustrating a flow of inputting information by a user in order to monitor a state of foods stored in the refrigerator according to an embodiment of the present disclosure.

According to an embodiment, the refrigerator 100 may record foods stored in the storage compartment 20 by having a camera inside of the body 10. A view inside application may represent an application for recording the inside of the storage compartment 20 and displaying recorded images. The camera may be installed an inner side of the door 30 to record the state of the storage compartment 20 from a user's view.

When a user selects the view inside application, the camera may record the inside of the storage compartment 20, and as illustrated in FIG. 28, the display 120a may display a view inside screen 126. When an inside image button 126a is selected by a user, the display 120a may display the recorded inside image (I). For example, a screen of FIG. 28 may be an initial screen when the view inside application is executed.

A user may select at least one food among foods displayed on the inside image (I). The selection of the food may be performed by touching food to be selected among foods displayed on the inside image (I).

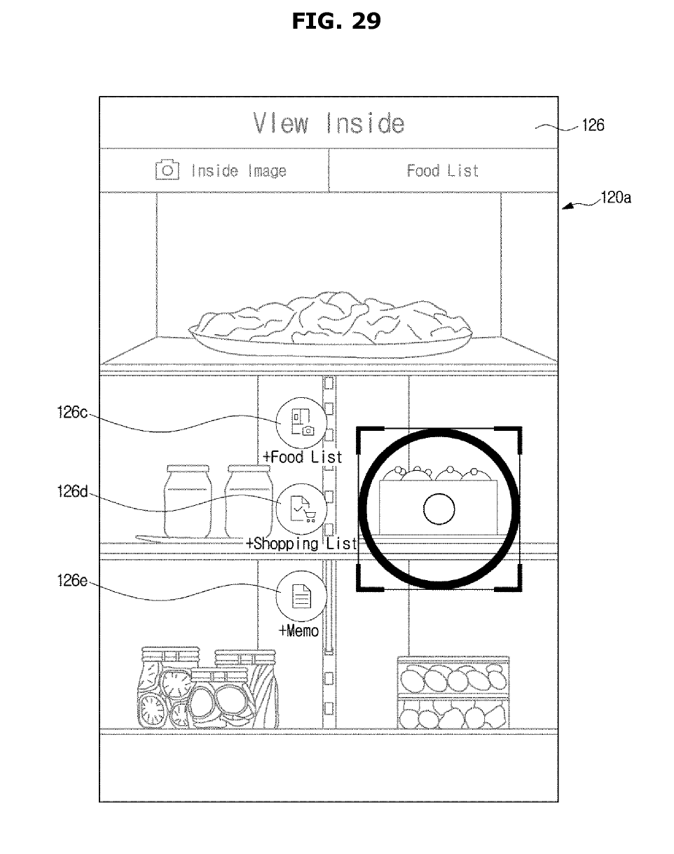

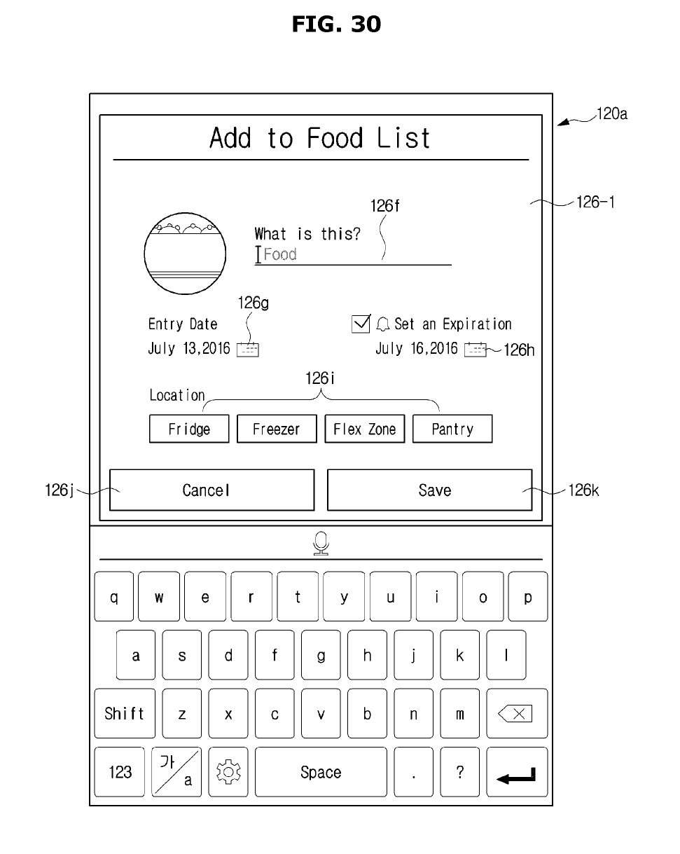

When the food is selected, function icons 125c, 126d and 126e, which are performed related to the selected food, may be displayed, as illustrated in FIG. 29. When a food list icon 126c is selected by a user, a food information input screen 126-1 for inputting information related to the selected food may be displayed, as illustrated in FIG. 30.

On the food information input screen 126-1, a tool for entering a name of the selected food 126f, a tool 126g for entering the date when the selected food is put into the refrigerator 100, a tool for entering an expiration data 126h and a tool for entering a location of the selected food 126i may be displayed.

When a user inputs needed information on the food information input screen 126-1 and selects a save button 126k, the selected food information may be matched with the input information and then stored in the storage 140, thereby returning to an initial screen. When a cancel button 126j is selected, the selection of the food may be cancelled and the screen may be returned to the initial screen. Therefore, the user may select another food on the inside image (I).

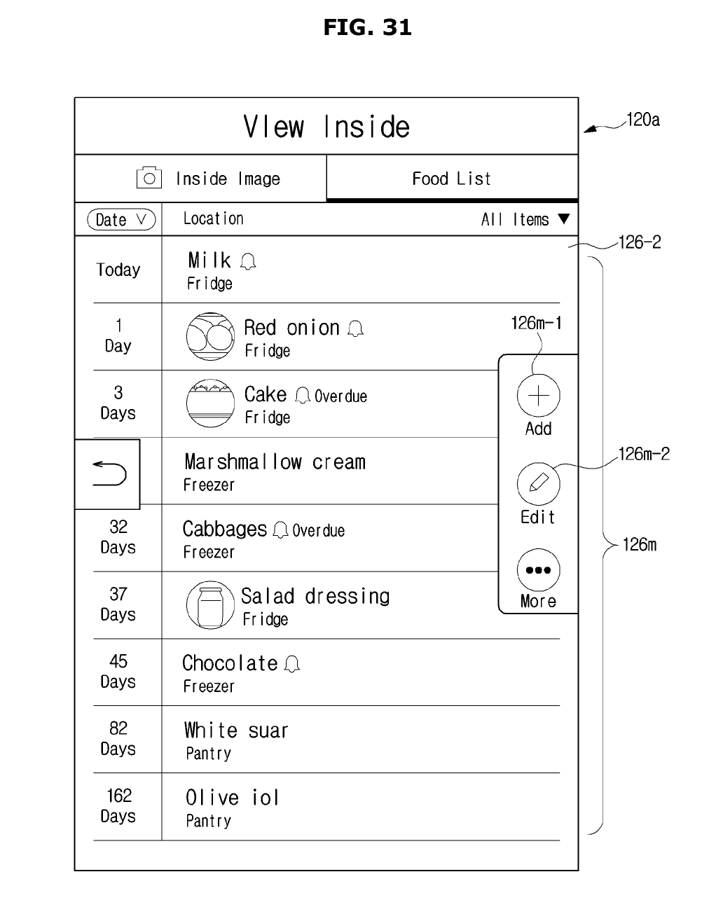

When a user selects a food information button 126b on the view inside screen 126, as illustrated in FIG. 31, a food information screen 126-2 displaying information related to foods currently stored in the refrigerator 100 may be displayed on the display 120a.

On the food information screen 126-2, a stored food list 126m indicating foods currently stored in the refrigerator 100 may be displayed. On the stored food list 126m, a name of the stored food, the location and a remaining day up to the expiration date (hereinafter referred to as a remaining day to expiration date) may be displayed. The information displayed on the stored food list 126m may be input by a user in the example of FIG. 30.

When a remaining day to expiration date is less than a predetermined date, it may be possible to further display an additional icon to indicate that an expiration date is less left.

When a user selects one food among foods on the stored food list 126m, detail information related to the selected food may be displayed on the display 120a. In addition, a screen for changing information related to the selected food may be displayed on the display 120a.

On one region of the food information screen 126-2, an add button 126m-1 for adding food information and an edit button 126m-2 for editing food information may be further displayed. When a user selects the add button 126m-1, the food information input screen 126-1 may be displayed, as illustrated in FIG. 30 and the user may add information related to the food stored in the refrigerator 100 using the food information input screen 126-1.

For example, when there is food which is not shown in the inside image (I), a user may input information related to the corresponding food by selecting the add button 126m-1 and add the food to the stored food list 126m.

When the edit button 126m-2 is selected, a user may edit the stored food list 126m. The edition of the stored food list 126m may include revising and deleting the information. A user may delete the name of the food, which is taken out from the refrigerator 100, on the stored food list 126m.

It may be possible to immediately delete the corresponding food by touching a region, which corresponds to the food to be deleted on the stored food list 126m,

A user may touch a region, which corresponds to the food to be deleted on the stored food list 126m, for longer than a predetermined time, thereby immediately deleting the corresponding food.

Information related to the food currently stored in the refrigerator 100 may be stored in the storage 140 or in the management server 200.

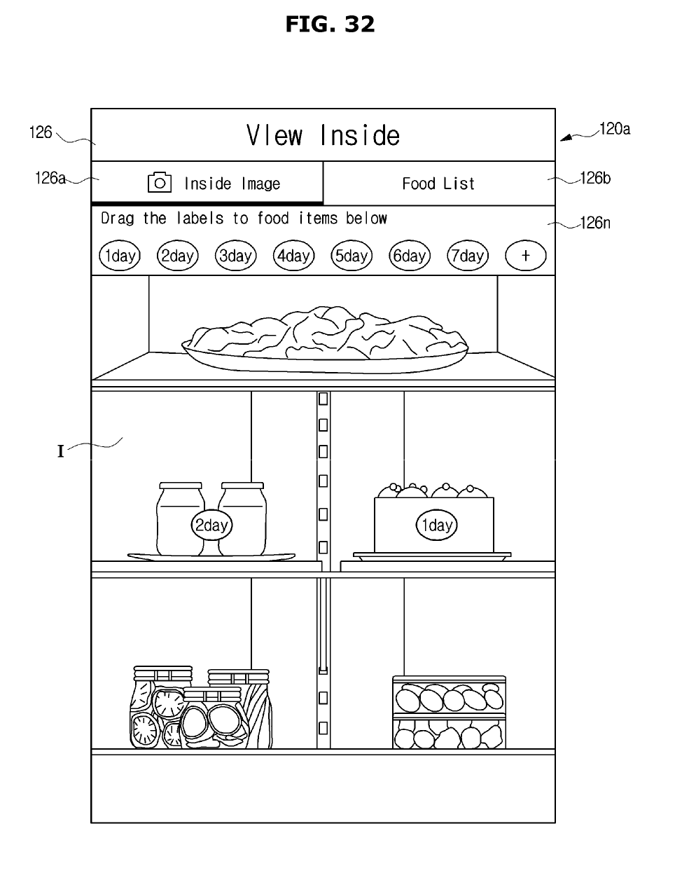

FIG. 32 is a view illustrating another example of a screen for inputting information related to expiration date of food stored in the refrigerator.

Referring to FIG. 32, in one region of the view inside screen 126, an expiration data tag list 126n may be displayed. When a user drags one of expiration data tags contained in the expiration data tag list 126n, and drops the tag on the food displayed on the inside image (I), the number of days corresponding to the expiration data tag may be stored as a remaining day to expiration date.

The inside image on which the expiration date tag is dropped on each food may be stored in the controller 110. When a user deletes the dropped expiration date tag, the controller 110 may determine that the food whose the expiration date tag is deleted is taken out from the refrigerator 100.

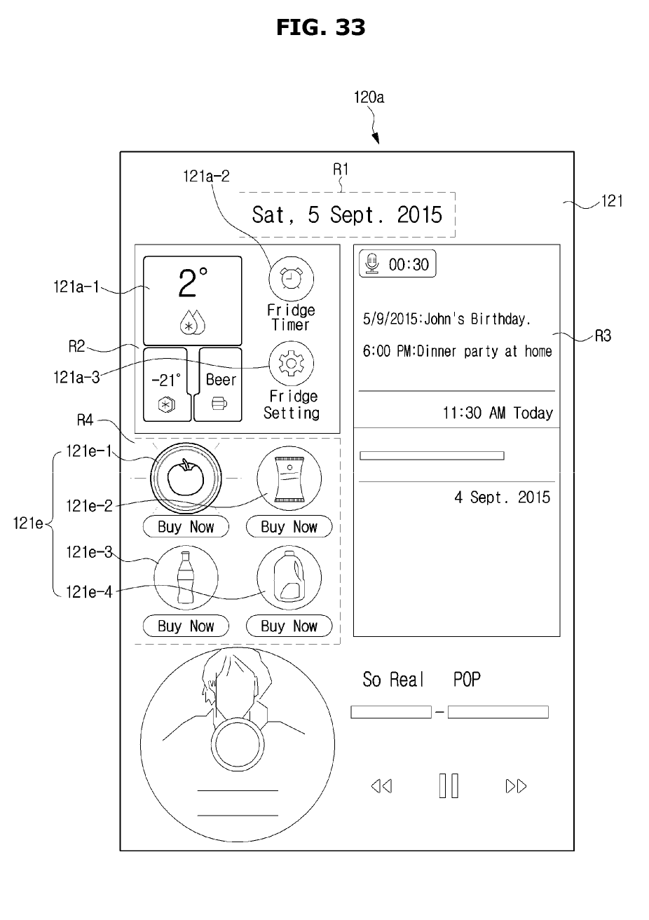

FIG. 33 is a view illustrating an example of a screen providing information related to a product needed to be ordered.

When among foods stored in the refrigerator 100, there is food having the expiration date expired, food whose the expiration date is coming soon or food taken out from the refrigerator 100, the display 120a may output a notification to induce the order of the corresponding product.

As illustrated in FIG. 33, when immediate order icons 121e-1, 121e-2, 121e-3, and 121e-4 for a plurality of products are displayed in the online shopping region (R4) of the home screen 121, the display 120a may output a notification for guiding the order by flashing the immediate order icon 121e-1 corresponding to a product needed to be ordered.

It may be possible to output a notification by changing the color or the size of the immediate order icon 121e-1 corresponding to the product needed to be ordered.

It may be possible to output a notification in an auditory manner through a speaker provided in the refrigerator 100 as well as a notification in a visual manner.

Whether food is needed to be ordered or not may be determined by the controller 110 of the refrigerator 100 or the management server 200.

For example, when there is food having expired expiration date, or there is food whose an expiration date is expired within a predetermined date based on the stored food information, the controller 110 or the management server 200 may determine that the corresponding food is required to be ordered. In addition, when it is confirmed that the food is taken out from the refrigerator 100 since a user deletes the food on the stored food list 126m or a user deletes the expiration date tag dropped on the food of the inside image (I), the controller 110 or the management server 200 may determine that the corresponding food is required to be ordered.

FIG. 33 illustrates that the immediate order icon 121e-1 corresponding to the food needed to be ordered is already displayed on the home screen 121, but embodiments of the refrigerator 100 is not limited thereto. According to the above mentioned embodiment, it may be possible to output a notification about the product needed to be ordered when the immediate order widget screen 123 is displayed. In addition, when the immediate order icon corresponding to the product is not displayed in advance, it may be possible to generate and display the immediate order icon.

An operation performed after the immediate order icon 121e-1 is selected by a user will be the same as the above mentioned embodiment.

Meanwhile, the refrigerator 100 may perform the order of components required for other home appliances. A detail description thereof will be described in detail with reference to the drawings.

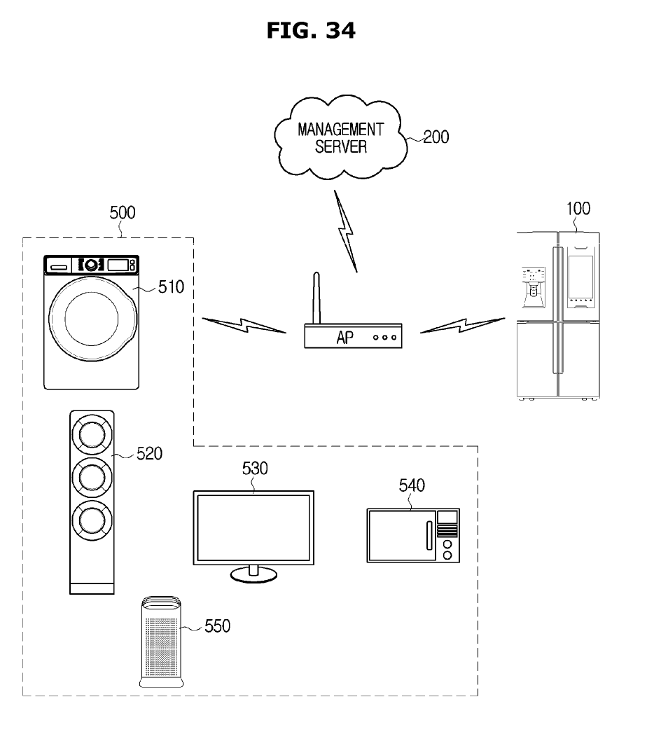

FIG. 34 is a view schematically illustrating a relationship among a plurality of home appliances which are connected to each other via a server.

For example, when the wireless communication module 131 of the refrigerator 100 is implemented as a Wi-Fi module, the refrigerator 100 may be connected to the management server 200 through a repeater (AP).

Further, a plurality of different home appliances 510, 520, 530, 540, and 550 located adjacent to the refrigerator 100 may be connected to the management server 200 through the repeater (AP). The refrigerator 100 may be connected to the plurality of different home appliances 510, 520, 530, 540, and 550 via the management server 200.

For example, the home appliances 510, 520, 530, 540, and 550 may include a washing machine 510, an air conditioner 520, a television 530, a microwave oven 540, and an air cleaner 550. In this case, the home appliances may be in the condition which is inappropriate to provide a variety of information to a user or to receive a variety of information from a user, e.g., a display is not provided, a display is significantly small, or a display is not implemented by a touch screen. Therefore, the refrigerator 100 may play a role of a hub among the plurality of home appliances so that the refrigerator 100 displays information related to the home appliances or receives an input from a user related to the home appliances.

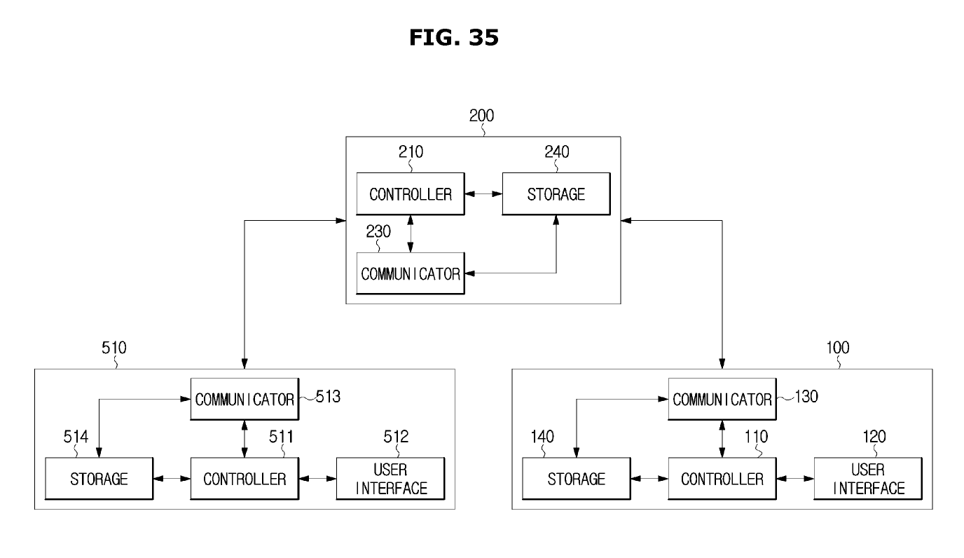

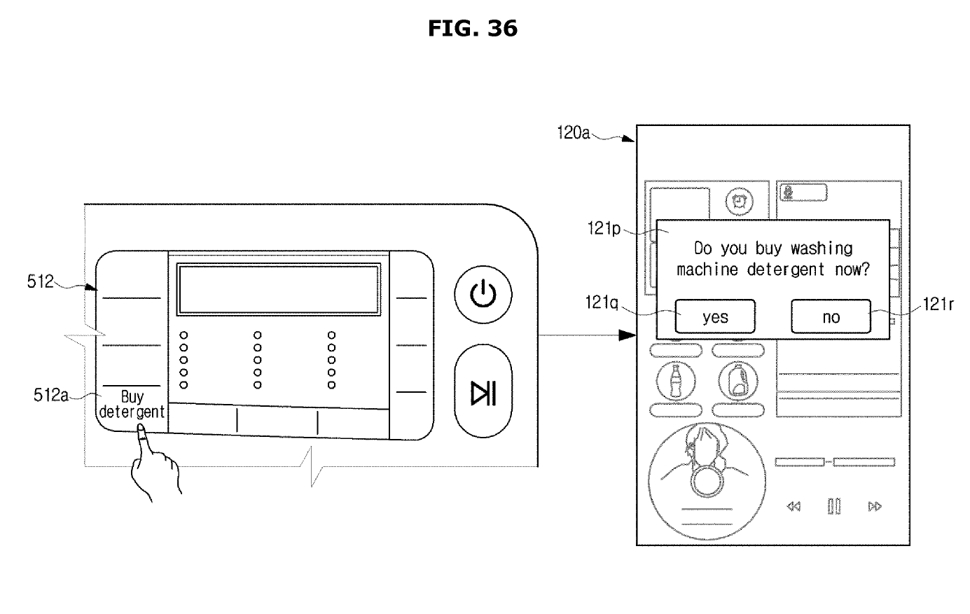

FIG. 35 is a control block diagram schematically illustrating a washing machine and a refrigerator which are connected to each other via a server, and FIG. 36 is a view illustrating a screen to order a product for the washing machine using a user interface of the refrigerator.

Referring to FIG. 35, the washing machine 510 may include a communicator 513 transmitting and receiving a signal by communicating with the management server 200, a storage 514 storing information for the control of the washing machine 510 or information indicating the state of the washing machine 510, a user interface 512 providing information to a user and receiving information from a user and a controller 511 controlling the washing machine 510 based on information stored in the storage 514 or information acquired from the outside via the communicator 513, or a user input received via the user interface 512.

The management server 200 includes a controller 210, a communicator 230 and a storage 260.

When there is a product for the washing machine 510, e.g., detergents, consumables whose replacement time has come, or components which fails or is damaged, the controller 511 may control the communicator 513 so that the communicator 513 transmits a order request signal for the corresponding product to the management server 200.

The controller 511 may determine whether to need the corresponding product by itself or by the user's input. For example, when the washing machine 510 automatically inputs detergent, the washing machine 510 may transmit a order request signal to the management server 200 by determining whether the detergent which automatically input is insufficient. Alternatively, the controller 511 may transmit a order request signal to the management server 200 by determining whether the replacement date of the consumables has come or not, or determining whether a component fails or is damaged.

Alternatively, as shown in FIG. 36, a user may input a order command about the corresponding product by operating an input device provided in the washing machine 510. For example, when a user perform washing using the washing machine 510, the user may determine whether to order the detergent and input a detergent order command by pressing or touching a detergent order button 512a.

The communicator 230 of the management server 200 may receive a detergent order request signal from the washing machine 510 and the controller 210 may control the communicator 230 again so that the communicator 230 transmits the detergent order request signal to the refrigerator 100.

The management server 200 may transmit the detergent order request signal to the refrigerator 100 that is registered to an account of the management server the same as the washing machine 510. The management server 200 may store identification information of home appliance that is registered according to an account, in the storage 240. When the detergent order request signal is transmitted from the washing machine 510, the management server 200 may search the refrigerator 100 that is registered to the accounts the same as the washing machine 510 and transmit the detergent order request signal to the searched refrigerator 100.

When the detergent order request signal of the washing machine 510 is transmitted from the management server 200, the refrigerator 100 may display a pop-up 121p for confirming whether to order the detergent of the washing machine, on the home screen 121. On the pop-up 121p, a order button 121p-1 and a reject button 121p-2 may be displayed.

Although the order button 121p-1 and the reject button 121p-2 are not displayed on the pop-up 121p, a user may input a order command by touching the pop-up 121p.

When a user selects the order button 121p-1 displayed on the pop-up 121p, it may be possible to automatically access a detergent shopping site and to omit a process, such as login, searching and selecting detergent, and inputting shipping information and payment information. Therefore, an order confirmation screen enabling a user to directly order the detergent may be displayed on the display 120a.

As mentioned description of the order of the product, e.g., filter, food and household items, when initially purchasing via the refrigerator 100, a procedure, such as logging in the corresponding site, selecting the product, and inputting shipping information and payment information, may be performed. After the initial one-time login, the order information may be stored and thus it may be possible to order detergent with a simple procedure, without inputting the same information repeatedly by a user.

Also, as for purchasing the detergent, when the detergent order command is input from a user, it may be possible to complete the order of the detergent with the order confirmation and to display the order confirmation screen.

In addition, according to the contract with the seller of the detergent shopping site, when the initial order, it may be possible to omit the login the corresponding site, and to identify a user (a order) using the account of the management server, and the sales server may acquire payment information and shipping information from user information stored in the account of the management server.

When there is detergent for the washing machine 510, the washing machine 510 may transmit information related to the detergent for the washing machine 510 to the management server 200 or the management server 200 may find out information related to the corresponding detergent by itself. The washing machine 510 may generate order information to be transmitted to the sales server 300, based on the information related to the detergent.

FIGS. 35 and 36 illustrate that the detergent of the washing machine 510 is ordered via the refrigerator 100, and a product for the use or the maintenance and repair of other home appliance other than the washing machine 510 may be ordered in the same manner.

For example, it is possible to request the order of the filter, which is used in the air cleaner 550 or the air conditioner 520, to the refrigerator 100. When determining whether to order the filter, it may be possible to input a filter order command by operating the user interface provided in the air cleaner 550 or the air conditioner 520. The air cleaner 550 or the air conditioner 520 may determine a filter replacement time by itself. Alternatively, the management server 200 may determine a filter replacement time of the air cleaner 550 or the air conditioner 520 to transmit the order information to the sales server 300 and to transmit a order request signal to the refrigerator 100.

According to the above-described example, it may be possible to order the product conveniently at the right time regardless of having a display in the home appliance.

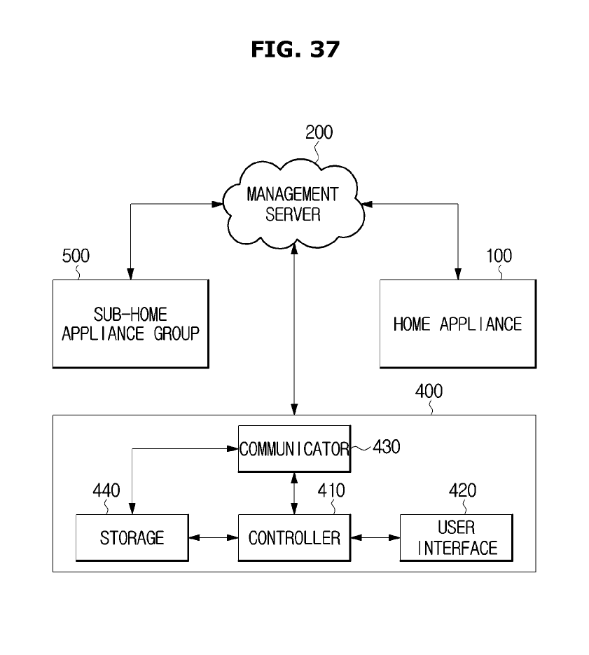

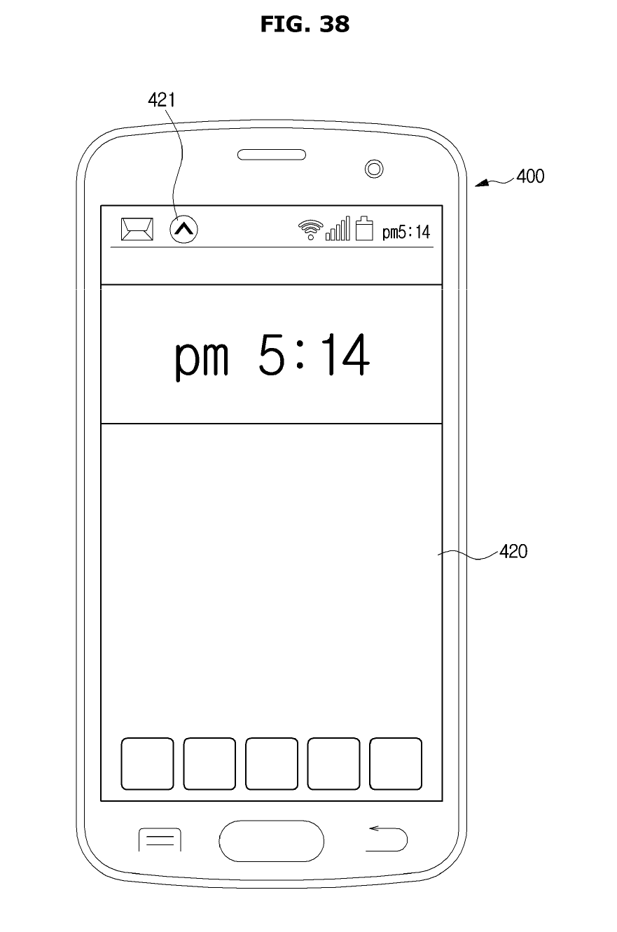

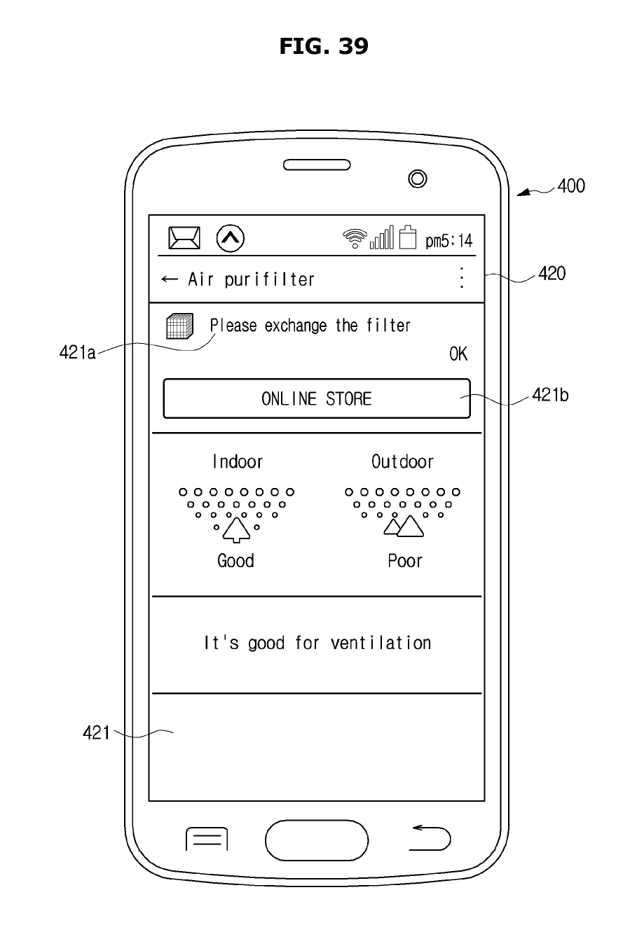

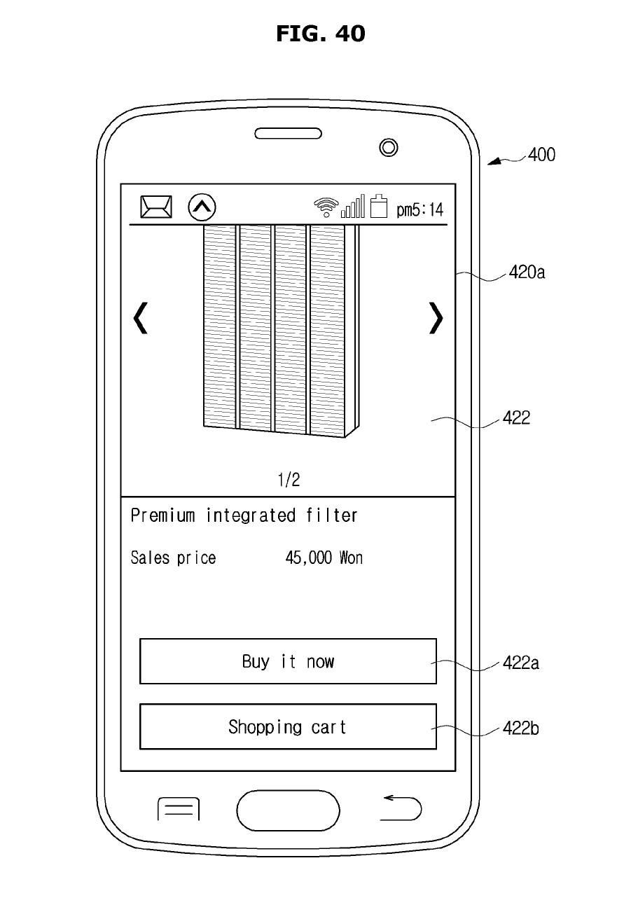

FIG. 37 is a control block diagram illustrating a mobile device connected to the management server, FIG. 38 is a view illustrating a method of outputting a notification to the mobile device, and FIGS. 39 and 40 are views illustrating an example of a screen when a product related to home appliances is ordered via the mobile device. According to the embodiment, a case in which the mobile device is a smart phone will be described as an example.

As mentioned above with reference to FIG. 15, the mobile device 400 may be connected to the management server 200. Referring to FIG. 37, the mobile device 400 may include a controller 410, an input and output interface 420, a communicator 430 and a storage 440.

In the embodiment, other home appliances other than the refrigerator 100 may be referred to as sub-home appliance group 500.

When it is required to order a product for the use or the maintenance and repair of the refrigerator 100, e.g., when it is required to replace the filter 154, it may be possible to transmit a order request signal of a filter for the refrigerator to the mobile device 400. As mentioned above, a home appliance management application may be installed in the mobile device 400.

When the management server 200 transmits the order request signal to the mobile device 400, a order alarm icon 421 may be displayed on a display 420a of the mobile device 400. The order alarm icon 421 may be displayed in a task bar at the top of the screen, as illustrated in FIG. 38.

For another example, the display 420a may display a pop-up indicating that it is required to order the filter of the refrigerator.

When it is required to replace a filter of the air cleaner 550, it may be possible to transmit a order request signal to the mobile device 400. When the order alarm icon 421 is displayed on the display 420a of the mobile device 400, and when a user accesses the management server 200 by executing the home appliance management application, a home screen 421 may be displayed on the display 420a, as illustrated in FIG. 39.

In one region of the home screen 421, a notification 421a indicating that it is required to replace a filter of the air cleaner, and when a user selects an online order button 421b, it may be possible to automatically access a site selling a filter of air cleaner.

Since a process, such as login, searching and selecting a filter, and inputting shipping information and payment information is omitted, the order confirmation screen 422 may be displayed on the display 420a to enable a user to directly order a filter.

As mentioned above, when initially purchasing via the mobile device 400, a procedure, such as logging in the corresponding site, selecting the product, and inputting shipping information and payment information, may be performed. After the initial one-time login, the order information may be stored and thus it may be possible to order the filter of the air cleaner with a simple procedure, without inputting the same information repeatedly by a user.

When a user selects a order button 422a of the order confirmation screen 422, it may be possible to complete the order of the filter of the air cleaner according to the order information that is automatically input. When a user wants to order another product on the site, the user may select a order schedule button 422b to add the filter to the order wish list.

Also, when a user selects the online order button 421b, it may be possible to complete the order of the filter of the air cleaner without the order confirmation and display the order confirmation screen.

In addition, according to the contract with the seller of the filter shopping site, even when the initial order, it may be possible to omit the login the corresponding site, and to identify a user (a purchaser) using the account of the management server, and the sales server may acquire payment information and shipping information from user information stored in the account of the management server.

The air cleaner 550 may transmit information related to the filter to the management server 200, or the management server 200 may find out information related to the corresponding filter by itself. The air cleaner 550 may generate order information to be transmitted to the sales server 300, based on the information related to the filter. In this case, the search and selection of the filter may be omitted despite of the initial order.

Hereinafter, an embodiment relates to a control method of a home appliance will be described.

The home appliance 100 and the management server 200 described above may be used to perform a control method for the home appliance according to an embodiment. Thus, the above-described information may be applied to an embodiment of the control method of the home appliance.

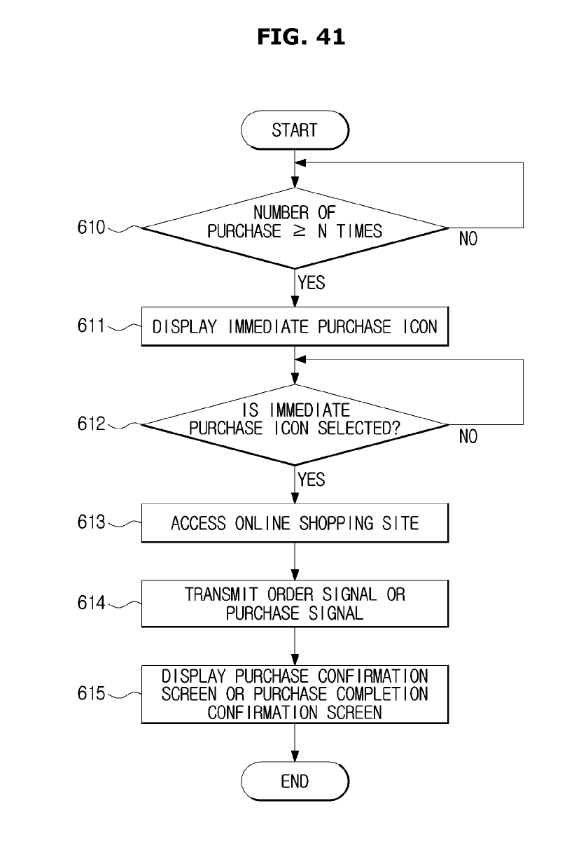

FIG. 41 is a flowchart illustrating generating and displaying the immediate order icon in a control method of the home appliance according to an embodiment of the present disclosure. A description thereof may correspond to the example of FIGS. 17 to 21.

Referring to FIG. 41, it is determined whether the number of times of the order of the product is equal to or more than a predetermined number (N times, N is an integer of 1 or more) (610). The number of times of the order of the product may be counted according to the home appliance 100 or the account assigned to the online shopping site.

For example, it may be possible to count the order performed via the home appliance 100 or to count the order performed via the mobile device 400 connected to the refrigerator 100 through the management server 200 without using the home appliance 100. In addition, it may be possible to count the order performed on the online shopping site by logging in the site regardless of the order via the home appliance 100 and the mobile device 400.

When the number of times of purchasing the same product is equal to or more than N times (YES in 610), the immediate order icon about the corresponding product may be generated and displayed on the display 120a (611).

When the immediate order icon is selected by a user (YES in 612), an order signal or a order signal may be transmitted to the sales server based on the pre-stored order information (613) and it may be possible to access an online shopping site (614). The user's selection may be input by touching the immediate order icon 121d. The pre-stored order information may be input when an initial order is performed. The pre-stored order information may include information related to the corresponding product, shipping information and payment information.

The display 120a of the home appliance 100 may display a order confirmation screen and a order completion confirmation screen according to the pre-stored order information (615). The order confirmation screen (S2) may represent a screen in a step before the order of the product corresponding to the selected immediate order icon 121d is completed. The order confirmation screen (S2) may be displayed when a signal transmitted to the sales server 300 is the order signal. On the order confirmation screen (S2), information related to a product to be ordered, shipping information and payment information may be displayed and when a user immediately selects the order button (S21), the order of the corresponding product may be completed.

When a signal transmitted to the sales server 300 is the order signal, the order completion confirmation screen (S3) may be displayed. The order completion confirmation screen (S3) may represent a screen in a step after the order of the product corresponding to the selected immediate order icon 121d is completed. On the order completion confirmation screen (S3), information related to the ordered product, shipping information and payment information may be displayed.

When a user selects the order button (S21) on the order confirmation screen (S2), the order of the corresponding product may be completed, and when the order cancel button (S31) is not selected on the order completion confirmation screen (S3), the order of the corresponding product may be confirmed.

The controller 110 of the refrigerator 100 may be a subject to determine the number of times of purchasing a product and to transmit an order signal or a order signal based on the pre-stored order information.

Alternatively, the controller 210 of the management server 200 connected to the refrigerator 100 may determine the number of times of purchasing a product and transmit an order signal or a order signal based on the pre-stored order information.

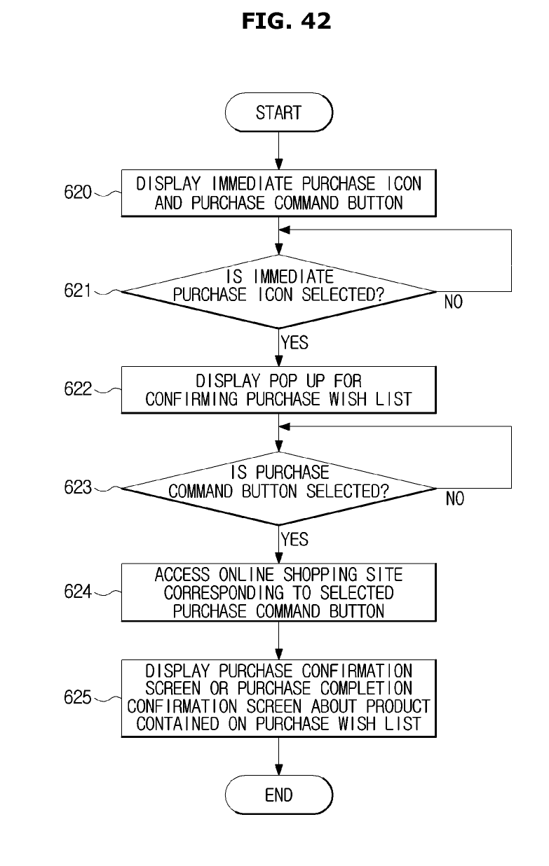

FIG. 42 is a flowchart illustrating another example of a method of purchasing a product by selecting the immediate order icon in the control method of the home appliance according to an embodiment of the present disclosure. A description thereof may correspond to the example of FIGS. 24 to 27.

The immediate order icon and the order command button may be displayed (620). The immediate order icon and the order command button may be displayed on the home screen 121 on which the display 120a of the home appliance 100 is displayed or the immediate order widget screen 123.

As mentioned above, the immediate order icon may be generated based on the product order history of the user. The immediate order icon may be generated according to the product and thus a plurality of immediate order icons may be displayed. The order command button may be generated according to the seller and thus a plurality of order command icons may be displayed.

When the immediate order icon is selected by a user (621), a product corresponding to the selected immediate order icon may be added to the order wish list, and a pop up may be displayed on the display 120a to confirm that the product is added to the order wish list (622).

When the immediate order icon is selected, an order signal about the product corresponding to the selected immediate order icon may be transmitted to the sales server of the seller corresponding to the selected immediate order icon.

Alternatively, the selection of the immediate order icon may be insufficient to transmit the order signal to the sales server. The order wish list may be stored in the storage 140 according to the selection of the immediate order icon, and when the order command button 123j and 123k is selected, it may be possible to transmit the order signal to the sales server.

When the order command button is selected by a user (YES in 623), it may be possible to access a shopping site corresponding to the selected order command button (624).

The display 120a may display the order confirmation screen or the order confirmation screen about products contained in the order wish list (625).

When the order command is selected, the order signal or the order signal may be transmitted to the sales server. When the order signal is transmitted, the order confirmation screen may be displayed and when the order signal is transmitted, the order confirmation screen may be displayed.

At least one product that is added by selecting the immediate order icons 123d, 123e and 123f by a user may be included in the order wish list, and the order confirmation screen (S4) displaying the order wish list may be displayed with the product information and the shipping information.

The user may complete the order of the selected product by selecting only some of the products included in the order wish list and by selecting an order selected product button (S41). It is also possible to complete the order of all products by selecting an order all products button (S42).

In this case, on the online shopping site of the seller, a process such as login, inputting shipping information, and inputting payment information may be omitted, and thus a user may complete the order of the product by only selecting the order button (S41 and S42).

When the order confirm signal is transmitted, the order completion confirmation screen (S5) which is after the order of the product is completed may be displayed on the display 120a, as illustrated in FIG. 27

On the order completion confirmation screen (S5), information related to the ordered product, shipping and payment may be displayed. In addition, a order cancel button (S51) for canceling the order may be displayed. When the order cancel button (S51) is not selected, the order of the corresponding product may be confirmed.

As mentioned above, the controller 110 of the refrigerator 100 or the controller 210 of the management server 200 may be a subject to transmit an order signal or a order signal based on the pre-stored order information.

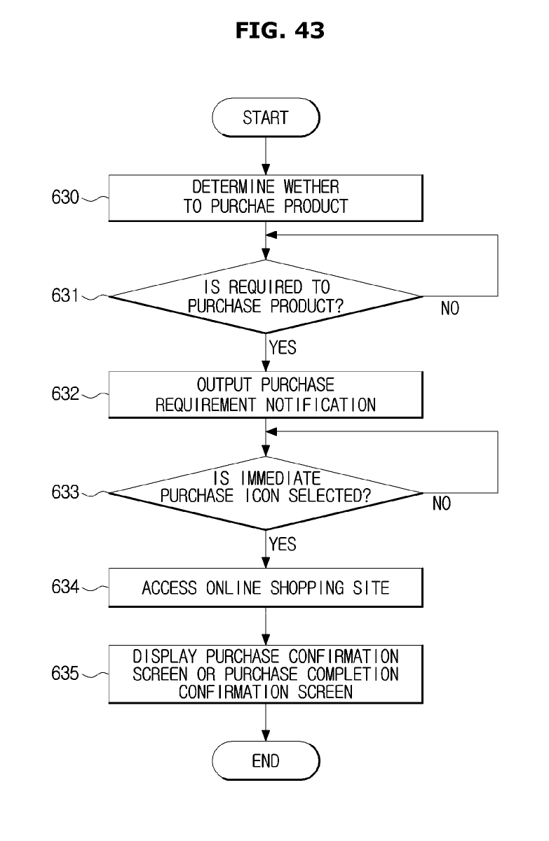

FIG. 43 is a flowchart illustrating a method of outputting a notification about whether to order a product in the control method of the home appliance according to an embodiment of the present disclosure. A description thereof may correspond to the example of FIGS. 7 to 9 and 28 to 33.

Referring to FIG. 43, it may be determined whether it is required to order a product (630). For example, whether it is required to order a component of the home appliance 100 for the use or maintenance and repair of the home appliance, e.g. a filter of the refrigerator, may be determined based on the replacement date or whether a component fails or is damaged.

Alternatively, it may be determined whether it is required to order food according to the expiration date of the food stored in the refrigerator or whether food stored in the refrigerator is taken out from the refrigerator.

When it is determined that it is required to order a product (YES in 631), a order requirement notification may be output (632). For example, a notification may be output in a visual manner by flashing or changing the size or the color the immediate order icon corresponding to the product that is required to be ordered.

When the immediate order icon corresponding to the product is not displayed, it may be possible to generate and display the immediate order. Alternatively, the notification may be output by displaying a pop-up window on the home screen 121 of the display 120a. In addition, it may be possible to output a notification in an audio manner.

When a user selects the immediate order icon corresponding to the product that is required to be ordered (YES in 633), it may be possible to access an online shopping site of the corresponding product (634) and transmit an order signal or a order signal about the product corresponding to the selected immediate order icon (635).

Since a process, such as login, searching and selecting a product, and inputting shipping information and payment information is omitted, the order confirmation screen may be displayed to enable a user to directly order the corresponding product or the order confirmation screen may be displayed when the order is completed without the order confirmation (636).

When the home appliance 100 outputs a order requirement notification related to the other home appliance 500 connected via the management server 200, and when a order command is input from a user, the home appliance 100 may automatically access the shopping site of the corresponding product to transmit an order signal or a order signal about the corresponding product.

For example, when it is required to replace a filter of the air conditioner or the air cleaner, it may be possible to output a order requirement notification on the display of the refrigerator in order to order the filter via the refrigerator. In addition, when it is required to order detergent of the washing machine, it may be possible to output the order requirement notification on the display of the refrigerator in order to order the detergent via the refrigerator.

In this case, the home appliance 100 may determine that it is required to order a product when a order product request signal of the other home appliance is input from the management server 200.

Alternatively, it may be possible to output the order requirement notification and to order the product via the mobile device 400. In this case, the determination of whether it is required to order a product may be performed by each home appliance 100 and 500 or by the management server 200.

As is apparent from the above description, according to the proposed home appliance, mobile device and control method of the same, it may be possible to enable a user to easily order a product at the appropriate time by outputting information related to a product for the use or maintenance and repair of the home appliance and by minimizing the order procedure of the corresponding product.

By configuring a graphical user interface based on the product order history of the user, it may be possible to enable a user to quickly and conveniently re-order a product without repeating an operation, which is performed when previously purchasing a product.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A home appliance comprising:
a user interface configured to display at least one immediate order icon to order at least one product corresponding to the displayed at least one immediate order icon immediately when the at least one immediate order icon is selected, and configured to receive a user's selection related to the displayed at least one immediate order icon;
a controller configured to generate order information to order a product corresponding to the selected at least one immediate order icon, when the user's selection related to the at least one immediate order icon is received; and
a communicator configured to transmit the generated order information to a sales server which processes an order of the product corresponding the selected at least one immediate order icon based on the generated order information.

2. The home appliance of claim 1, wherein
the controller is configured to generate the order information based on information related to the product corresponding the selected at least one immediate order icon, the information including at least one of shipping information of the user and payment information about a payment method used to order the product.

3. The home appliance of claim 1, wherein
the controller is configured to generate the order information based on a previously ordered history of the product corresponding to the selected at least one immediate order icon.

4. The home appliance of claim 1, wherein
the controller is configured to access the sales server which processes the order of the product corresponding to the selected at least one immediate order icon when the user's selection related to the at least one immediate order icon is received; and the user interface displays a screen provided from the sales server.

5. The home appliance of claim 1, wherein
the communicator transmits an order signal to order the product corresponding to the selected at least one immediate order icon, together with the order information to the sales server.

6. The home appliance of claim 1, wherein
the communicator transmits a order signal to order the product corresponding to the selected at least one immediate order icon, together with the order information to the sales server.

7. The home appliance of claim 6, wherein
the user interface displays a order completion confirmation information which indicates that the order based on the order information is completed.

8. The home appliance of claim 1, wherein
the communicator is connected to a management server which manages home appliances and is configured to transmit the order information to the sales server via the management server.

9. The home appliance of claim 1, wherein
the controller is configured to generate the at least one immediate order icon based on a number of products to order, and is configured to control the user interface so that the user interface displays the generated at least one immediate order icon.

10. The home appliance of claim 1, wherein
when it is determined that it is required to order the product, the controller is configured to control the user interface so that the user interface outputs an order requirement notification information which indicates that it is required to order the product.

11. The home appliance of claim 10, wherein
the communicator is configured to receive a order request signal of a product, which is needed for other home appliance among a plurality of home appliances, from the management server which manages the plurality of home appliances.

12. The home appliance of claim 1, wherein
when the user's selection related to the at least one immediate order icon is received, the user interface displays a pop-up window which indicates that the product corresponding to the selected at least one immediate order icon is added to an order wish list.

13. The home appliance of claim 12, wherein
the user interface further displays a order command button to order at least one product contained on the order wish list according to the sales server.

14. The home appliance of claim 1, wherein
the product comprises at least one of a filter used in a refrigerator, a filter used in an air conditioner, and a filter used in an air cleaner, foods stored in a refrigerator and detergent used in a washing machine.

15. The home appliance of claim 14, wherein
when at least one of the filter of the refrigerator, the filter of the air conditioner and the filter of the air cleaner is ordered, the controller is configured to provide a replacement guide screen for the filter to the user interface for a predetermined period of time or until it is confirmed that the filter is replaced.

16. A control method of a home appliance comprising:
displaying at least one immediate order icon, on a display, to order at least one product corresponding to the displayed at least one immediate order icon immediately when the at least one immediate order icon is selected;
receiving a user's selection of the at least one immediate order icon;
generating order information to order a product corresponding to the selected at least one immediate order icon when the user's selection of the at least one immediate order icon is received; and
transmitting the generated order information to a sales server which processes an order of the product corresponding to the selected at least one immediate order icon based on the generated order information.

17. The control method of claim 16, wherein
the generation of the order information comprises generating the order information based on information related to the product corresponding the selected at least one immediate order icon, shipping information of the user and payment information about a payment method used to order the product.

18. The control method of claim 16 further comprising:
accessing the sales server which processes the order of the product corresponding to the selected at least one immediate order icon when the user's selection related to the at least one immediate order icon is received; and displaying a screen provided from the sales server.

19. The control method of claim 16 further comprising:
transmitting an order signal to order the product corresponding to the selected at least one immediate order icon, together with the order information to the sales server.

20. The control method of claim 16 further comprising:
receiving an order request signal of a product, which is needed for other home appliance among a plurality of home appliances, from a management server which manages the plurality of home appliances.
